(19) United States
(12) Patent Application Publication
(10) Pub. No.: US 2026/0150028 A1
(43) Pub. Date: May 28, 2026

(54) METHODS FOR MULTI-HOP UE-TO-UE RELAY UNICAST IP ROUTING

(71) Applicant: InterDigital Patent Holdings, Inc., Wilmington, DE (US)

(72) Inventors: Joe Huang, Montville, NJ (US); Jung Je Son, Warrington, PA (US); Sudhir Pattar, Mount Laurel, NJ (US); Phillip Leithead, King of Prussia, PA (US); Kyle Jung-Lin Pan, Saint James, NY (US)

(73) Assignee: InterDigital Patent Holdings, Inc., Wilmington, DE (US)

(21) Appl. No.: 18/962,045

(22) Filed: Nov. 27, 2024

(51) Int. Cl. H04W 40/22; H04W 40/24

(52) U.S. Cl. CPC H04W 40/22; H04W 40/248

(57) ABSTRACT

A wireless transmit/receive unit (WTRU)-to-WTRU relay (Relay1) may be configured to receive a first message from a source WTRU (WTRU1), store a route entry to WTRU1 in a unicast routing table, send a second message to a second WTRU-to-WTRU relay (Relay2), receive a third message from Relay2, store a route entry to WTRU2 in the unicast routing table, store an association of a user information identification (ID) of WTRU2 and the IP address of WTRU2, store an IP route entry to WTRU2 in a unicast IP routing table, send a fourth message to WTRU1, store an association of a user information ID of WTRU1 and the IP address of WTRU1, store an IP route entry to WTRU1 in the unicast IP routing table, and send a fifth message to WTRU2 via Relay2.

### STATEMENT OF GOVERNMENT RIGHTS

This invention was made with Government support under Contract No. N00014-21-C-1080 awarded by the Office of Naval Research. The Government has certain rights in the invention.

### BACKGROUND

5G ProSe defined several features and procedures such as 5G ProSe Direct Discovery, 5G ProSe Direct Communication, 5G ProSe UE-to-Network (U2N) Relay, and 5G ProSe UE-to-UE (U2U) Relay. 5G ProSe UE-to-UE Relay enables indirect communication between two End UEs. For a UE-to-UE Relay, 5G ProSe UE-to-UE Relay Discovery and 5G ProSe Communication via UE-to-UE Relay are defined.

For 5G ProSe UE-to-UE Relay Discovery, both Model A and Model B discovery are supported: Model A uses a single discovery protocol message (Announcement). Model B uses two discovery protocol messages (Solicitation and Response). Discovery integrated into a PC5 unicast link establishment procedure is supported.

5G ProSe Communication via a UE-to-UE Relay is possible with a Layer2 UE-to-UE Relay or a Layer3 UE-to-UE Relay. For a Layer2 UE-to-UE Relay and Layer3 UE-to-UE Relay, 5G ProSe communication setup with discovery procedures is defined. Discovery integrated into a PC5 unicast link establishment procedure is defined.

With a Layer2 UE-to-UE Relay, an end-to-end PC5 link is established between the End UEs via the Relay. PC5-S messages may then be exchanged between End UEs.

With a Layer3 UE-to-UE Relay, each End UE establishes a PC5 link with the Relay and the Relay forwards messages towards End UEs. PC5-S messages are exchanged between End UEs and the Relay.

With a Layer3 UE-to-UE Relay, when an IP based data connection is used, after a PC5 link is setup with the Relay, each End UE may be assigned an IP address by the Relay which may be based on a Dynamic Host Configuration Protocol (DHCP) procedure or each End UE may assign its own IP address, which may be based on a link local IP address assignment procedure and inform the Relay. Whether a DHCP or link local IP address assignment is used is determined during a security connection setup between an End UE and the UE-to-UE Relay.

### SUMMARY

A method may be performed in a wireless transmit/receive unit (WTRU)-to-WTRU relay (Relay1). The WTRU-to-WTRU relay (Relay1) may be configured to receive a first message from a source WTRU (WTRU1). The first message may comprise a proactive domain name server (DNS) query for a target WTRU (WTRU2) Internet Protocol (IP) address. Relay1 may be configured to store a route entry to WRTU1 in a unicast routing table. Relay1 may be configured to send a second message to a second WTRU-to-WTRU relay (Relay2). The second message may comprise a proactive DNS query for an IP address of WTRU2. Relay1 may be configured to receive a third message from Relay2. The third message may comprise a proactive DNS query for an IP address of WTRU1 and comprise an IP address of WTRU2. Relay1 may be configured to store a route entry to WTRU2 in the unicast routing table. Relay1 may be configured to store an association of a user information identification (ID) of WTRU2 and the IP address of WTRU2. Relay1 may be configured to store an IP route entry to WTRU2 in a unicast IP routing table, based on the route entry to WTRU2 in the unicast routing table and the association between the user information ID of WTRU2 and the IP address of WTRU2. Relay1 may be configured to send a fourth message to WTRU1. The fourth message may comprise the IP address of WTRU2. Relay1 may be configured to allocate and send an IP address to WTRU1. Relay1 may be configured to store an association of a user information ID of WTRU1 and the IP address of WTRU1. Relay1 may be configured to store an IP route entry to WTRU1 in the unicast IP routing table, based on the route entry to WTRU1 in the unicast routing table and the association between the user information ID of WTRU1 and the IP address of WTRU1. Relay1 may be configured to send a fifth message to WTRU2 via Relay2. The fifth message may be a DNS response message and may comprise an IP address of WTRU1.

The first message may be a direct communication request (DCR) or a link modification request (LMR). The first message may comprise one or more of: a user information identification (ID) of WTRU1; a user information ID of WTRU2; routing information based on a WTRU-to-WTRU relay discovery; an indication of a hop count from WTRU1; a relay service code (RSC); and a Layer-2 ID of WTRU2. The route entry to the source WTRU in the unicast routing table may comprise one or more of: a user information identification (ID) of WTRU1; an indication of a number of hops to WTRU1; a next hop information (directly connected); and Layer-2 ID of WTRU1. The second message may be a direct communication request (DCR) or a link modification request (LMR). The second message may comprise one or more of: a user information identification (ID) of WTRU1; a user information ID of Relay1; a user information ID of WTRU2; routing information; an indication of a hop count from WTRU1; a relay service code (RSC); and a Layer-2 ID of WTRU2. The third message may be a direct communication accept (DCA) or a link modification accept (LMA). The third message may comprise one or more of: a user information identification (ID) of WTRU1; a user information ID of WTRU2; a user information ID of Relay2; an indication of a hop count from WTRU2; and a relay service code (RSC). The route entry to WTRU2 in the unicast routing table may comprise one or more of: a user information identification (ID) of WTRU2; an indication of a number of hops to WTRU2; a user information ID of Relay2; and a Layer-2 ID of Relay2. The route entry to WTRU2 in the unicast IP routing table may comprise one or more of: the IP address of WTRU2; an indication of a number of hops to WTRU2; and a Layer-2 ID of Relay2. The fourth message may be a direct communication accept (DCA) or a link modification accept (LMA). The fourth message may comprise one or more of: a user information ID of WTRU1, a user information ID of WTRU2, a user information ID of Relay1, an indication of a hop count from WTRU2, and a relay service code (RSC). The IP route entry to WTRU1 in the unicast IP routing table may comprise one or more of: the: IP address of WTRU1; an indication of a number of hops to WTRU1; and a Layer-2 ID of WTRU1. The fifth message may be sent based on the proactive DNS query for a source IP address being included in the received third message from Relay2.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 show an example configuration for multihop UE-to-UE relay link establishment;

FIG. 3 shows an example procedure for Unicast IP Routing Table setup with proactive Domain Name Server (DNS) query;

FIG. 4 shows an example procedure for a U2U relay UE for Unicast IP Routing Table setup with proactive DNS query;

FIG. 5 shows an example procedure for Unicast IP Routing Table setup with delegate IP address assignment;

FIG. 6 shows an example procedure for a U2U relay UE for Unicast IP Routing Table setup with delegate IP address assignment;

FIG. 7 shows an example procedure for Unicast IP Routing Table setup with a predetermined IP address; and

FIG. 8 shows an example procedure for a U2U relay UE for Unicast IP Routing Table setup with a predetermined IP address.

### DETAILED DESCRIPTION

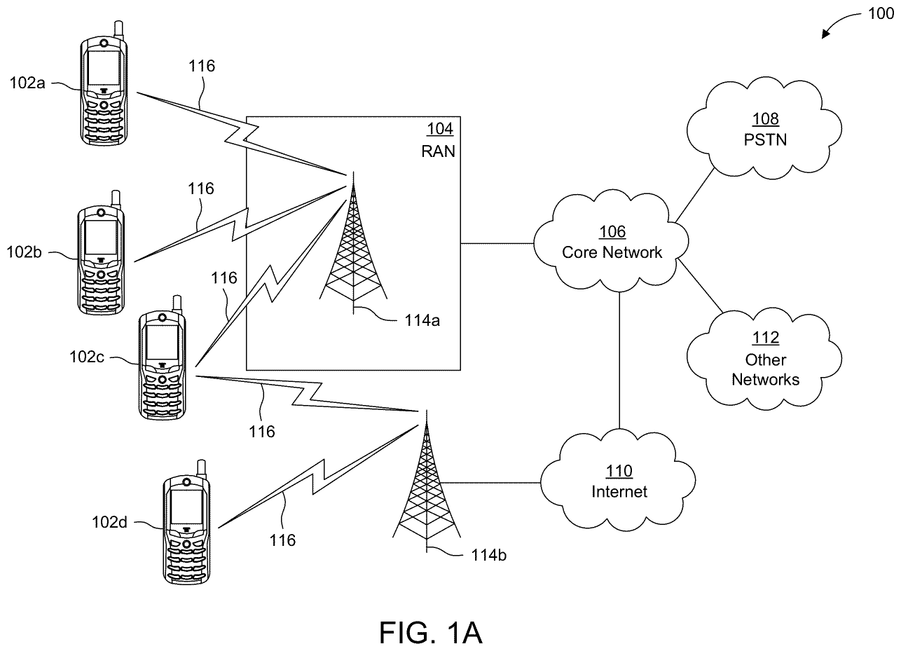

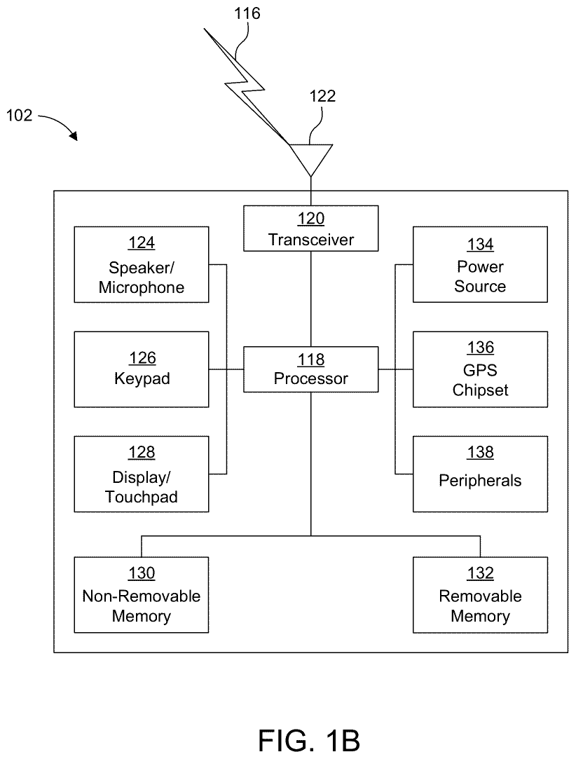

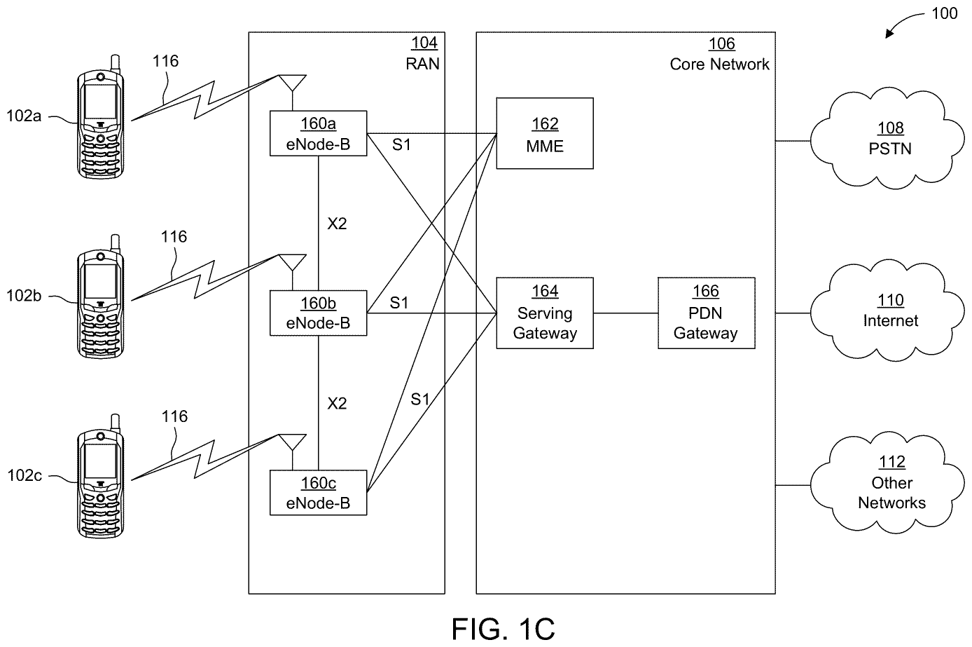

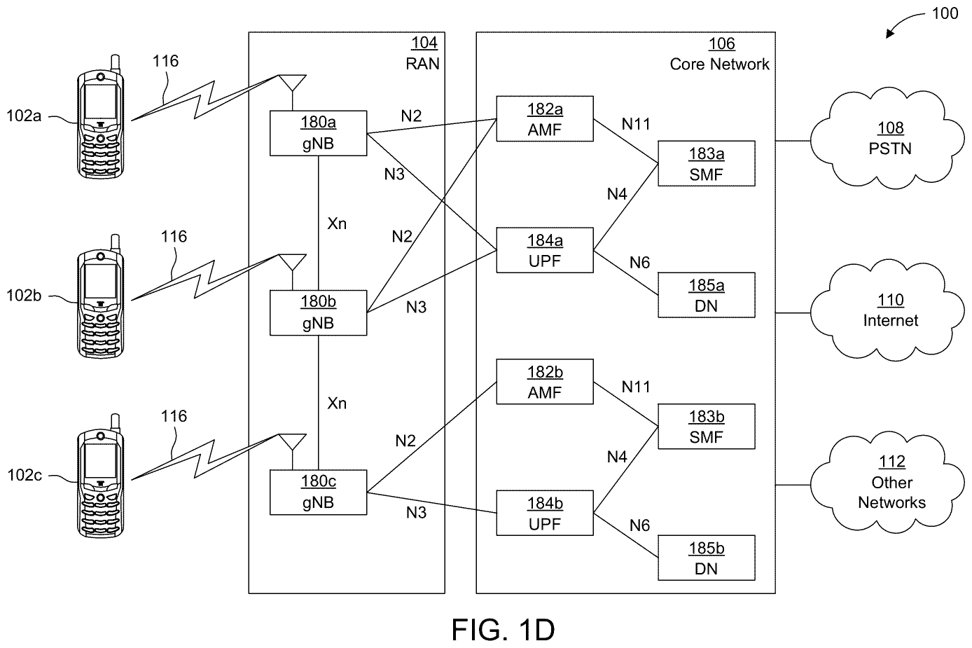

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102 a, 102 b, 102 c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c ). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c . For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180 a, 180 b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114 a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Herein, UE may be used interchangeably with WTRU and a UE-to-UE relay or U2U relay may be used interchangeably with a WTRU-to-WTRU relay or W2W relay.

After a connection setup between two End UEs via a UE-to-UE Relay, each End UE may keep monitoring the channel status of a PC5 link and when a link quality goes below a threshold value, the End UE may select another UE-to-UE Relay for the connection between two End UEs.

For UE-to-UE Relay Reselection, UE-to-UE Relay Discovery procedures may be used or the negotiated 5G ProSe UE-to-UE Relay Reselection procedure may be used.

In the negotiated UE-to-UE Relay Reselection, one End UE may initiate the UE-to-UE Relay Reselection procedure. End UEs may negotiate a new UE-to-UE Relay using the existing connection and establish the communication via the reselected UE-to-UE Relay prior to releasing the communication via the current 5G ProSe UE-to-UE Relay.

Multihop for UE-to-Network (U2N) Relay is to enable a Remote UE to discover and communicate with a U2N Relay via one or more U2U Relays. Multihop UE-to-UE (U2U) Relay is to enable End UEs to discover and communicate with each other via more than one U2U Relay.

The multihop capability is deemed crucial for mission critical communications (e.g., first responders) and in general needed to enhance coverage (e.g., indoor).

To support Layer-3 UE-to-UE Relay communication with IP traffic in a UE-to-UE relay mesh network, IP addresses need to be to be assigned for the source and target End UEs. The immediate U2U Relay of an End UE may act as a Dynamic Host Configuration Protocol (DHCP) server or IPv6 router to assign IP address for the End UE during link establishment, as well as a Domain Name Server (DNS) server which stores the association of the User Info IDs and IP addresses of the End UEs.

Currently, the target IP address may not be included in a Direct Communication Accept (DCA) or Link Modification Accept (LMA) message. If not, a separate DNS query may need to be sent by the source End UE to the immediate U2U Relay of the target End UE after end-to-end link establishment to learn the IP address of the target End UE. In addition, a separate DNS query may need to be sent by the target End UE to the immediate U2U Relay of the source End UE after end-to-end link establishment to learn the IP address of the source End UE. Sending of DNS queries after end-to-end link establishment introduces additional delay to start transferring user plane IP packets.

To exchange the user plane traffic, IP packets need to be routed from the source End UE to the target End UE and vice versa. To this end, a procedure is needed to construct the hop-by-hop IP routing table on and between source and target End UEs.

Solutions are needed on how to perform IP address assignment and set up an IP routing table hop by hop during link establishment for user plane Layer-3 UE-to-UE Relay Communication.

Herein, a UE-to-UE Relay (to be abbreviated as U2U Relay) refers to a UE which is authorized and behaves as a Relay UE to forward traffic between End UEs. A Multihop UE-to-UE Relay Discovery procedure may be performed by an End UE to discover a path to an announced (Model A) or a discoveree End UE (Model B) via one or more U2U Relays.

A Multihop UE-to-UE Relay Link Establishment procedure may be used to set up a PC5 connection over the end-to-end path. After (multihop) UE-to-UE Relay Discovery, the initiating End UE may establish connectivity or modify an existing PC5 link with a U2U Relay, through a Direct Communication Request (DCR) or a Link Modification Request (LMR). The U2U Relay may then establish connectivity with the next U2U Relay along the discovered path, through a DCR or LMR. The process may continue until the connectivity with the target end UE is established.

A proactive DNS query may be used to request the IP address information of a peer End UE before IP address assignment. If a proactive DNS query for a target IP address is included in a DCR/LMR by the source End UE, then the U2U Relay acting as a DHCP server for the target End UE may wait (e.g., for a preconfigured period of time) for the completion of the IP address assignment before sending out the DCA/LMA to include the target IP address. If a proactive DNS query for a source IP address is included in DCA/LMA by the target End UE, then the U2U Relay acting as a DHCP server for the source End UE may send out a DNS Response to the target End UE after the completion of the IP address assignment for the source End UE.

A Delegate IP Address Assignment Indication included in a DCR/LMR may be used by the source End UE to inform the target End UE to request a source IP address from a U2U relay as a DHCP server on behalf of the source End UE during link establishment. If a delegate IP address assignment indication is included in DCR/LMR by the source End UE, then the target End UE may request an IP address on behalf of the source End UE from an immediate U2U Relay acting as a DHCP server (or IPv6 Router), in addition to requesting an IP address for the target End UE, and the immediate U2U Relay of the target End UE may wait (e.g., for a preconfigured period of time) for the completion of the IP address assignment before sending out the DCA/LMA to include both the source and target IP addresses.

An IP address request indication included in a DCA/LMA sent by the target End UE may be used to indicate to the immediate U2U Relay acting as a DHCP server (or IPv6 Router) to wait (e.g., for a preconfigured period of time) for the completion of the IP address assignment before sending out the DCA/LMA to include the assigned target IP address.

A Unicast Routing Table (per Relay Service Code) may be used in the PC5 signaling plane (PC5-S) and may be set up during link establishment procedure. Upon the reception of a Link Modification Request (LMR) or in the security procedure after receiving a Direct Communication Request (DCR), a U2U Relay or an End UE may add an entry to the Unicast Routing Table to the source End UE, with a destination set to User Info ID of the source End UE, and a next-hop User Info ID/Layer-2 ID set to the sender User Info ID/source Layer-2-ID of the received message. Upon the reception of a Direct Communication Accept (DCA) or Link Modification Accept (LMA), a U2U Relay or an End UE may add an entry to the Unicast Routing Table to the target End UE, with a destination set to the User Info ID of the target End UE and next-hop User Info ID/Layer-2 ID set to the sender User Info ID/source Layer-2-ID of the received message.

A Unicast IP Routing Table (per Relay Service Code) may be used in the PC5 user plane (PC5-U) to route Layer-3 IP traffic. The route entry in the Unicast IP Routing Table may be set up based on the corresponding route entry in the Unicast Routing Table and the association between the Destination User Info ID and Destination IP address (with the same next-hop Layer-2 ID).

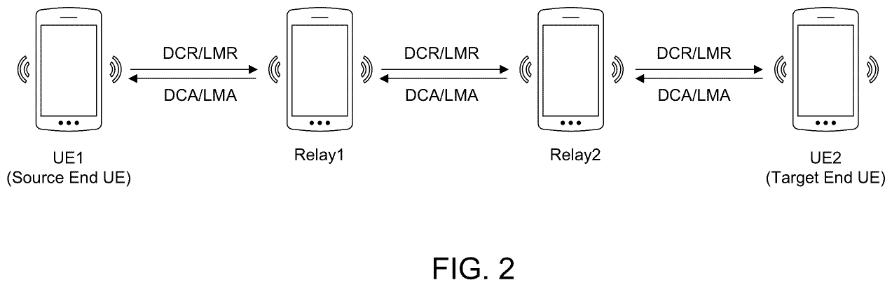

FIG. 2 shows an example configuration for multihop UE-to-UE Relay link establishment. A source End UE (UE1) may send a direct communication request (DCR)/link modification request (LMR) to a first relay (Relay 1). Relay1 may send a DCR/LMR to a second relay (Relay2). Relay2 may send a DCR/LMR to a target End UE (UE2). UE2 may send a direct communication accept (DCA)/link modification accept (LMR) to Relay2. Relay2 may send a DCA/LMA to Relay1. Relay1 may send a DCA/LMA to UE1.

In an embodiment, a Unicast IP Routing Table may be set up with proactive DNS query. A source End UE (UE1) may include a proactive DNS query for a target IP address in a DCR/LMR. A Unicast Routing Table may be updated hop by hop to include a route entry to UE1. A target End UE (UE2) may include a proactive DNS query for a source IP address and a U2U relay (Relay2) may include a target IP address in the DCA/LMA. Unicast Routing Tables and Unicast IP Routing Tables may be updated hop by hop to include a route entry to UE2 on each hop. A U2U relay (Relay1) may send a DNS response with a source IP address to UE2. Unicast IP Routing Tables may be updated hop by hop to include a route entry to the UE1 on each hop.

UE1 (Source End UE) may send a DCR or LMR to Relay1, which may include a proactive DNS query for a target IP address, and routing information obtained from UE-to-UE Relay Discovery. UE1 may receive a DCA/LMA from Relay1, including a target IP address. UE1 may add a route entry to UE2 into its Unicast Routing Table. UE1 may add a route entry to UE2 into its Unicast IP Routing Table based on the route entry to UE2 in its Unicast Routing Table and an association between the target User Info ID and the received target IP address. UE1 may request and receive a source IP address from Relay1 (acting as a DHCP server or an IPv6 Router). UE1 may exchange user plane IP traffic with UE2 via the Unicast IP Routing Tables hop by hop.

Relay1 (U2U Relay UE) may receive a DCR or LMR from UE1. Relay1 may perform a security establishment with UE1 if a DCR is received. Relay1 may add a route entry to UE1 into its Unicast Routing Table. Relay1 may send a DCR or LMR to Relay2, which may include a proactive DNS query for a target IP address, and routing information (e.g., obtained by removing itself out of the routing information received from UE1). Relay1 may receive a DCA/LMA from Relay2, including a target IP address (here, IP address of UE2). Relay1 may add a route entry to UE2 into its Unicast Routing Table. Relay1 may add a route entry to UE2 into its Unicast IP Routing Table based on the route entry to UE2 in its Unicast Routing Table and an association between the target User Info ID and the received target IP address. Relay1 may send a DCA or LMA to UE1, which may include the target IP address (here, IP address of UE2). Relay1 may assign a (source) IP address (acting as a DHCP server or an IPv6 Router) for UE1. Relay1 may add a route entry to UE1 into its Unicast IP Routing Table based on the route entry to UE1 in its Unicast Routing Table and an association between the source User Info ID and the assigned source IP address. Relay1 may send a DNS Response to Relay2, which may include the assigned source IP address (here, IP address of UE1), if proactive DNS query for source IP address is included in the received DCA/LMA from Relay2.

Relay2 (U2U Relay UE) may receive DCR or LMR from Relay1. Relay2 may perform a security establishment with Relay1 if a DCR is received. Relay2 may add a route entry to UE1 into its Unicast Routing Table, with Relay1 as a next hop. Relay2 may send a DCR or LMR to UE2, which may include a proactive DNS query for target IP address. Relay2 may receive a DCA/LMA from UE2. Relay2 may add a route entry to UE2 into its Unicast Routing Table. Relay2 may assign a (target) IP address (acting as a DHCP server or an IPv6 Router) for UE2. Relay2 may add a route entry to UE2 into its Unicast IP Routing Table, based on the route entry to UE2 in its Unicast Routing Table and an association between the target User Info ID and the assigned target IP address. Relay2 may send a DCA or LMA to Relay1, which may include the assigned target IP address (here, IP address of UE2). Relay2 may send a DCA or LMA to Relay1, which may include a proactive DNS query for the source IP address, and target IP address (here, IP address of UE2). Relay2 may receive a DNS Response from Relay1, which includes the source IP address (here, IP address of UE1). Relay2 may add a route entry to UE1 into its Unicast IP Routing Table, based on the route entry to UE1 in its Unicast Routing Table and an association between the source User Info ID and the received source IP address. Relay2 may send a DNS Response to UE2, which may include the source IP address (here, IP address of UE1).

UE2 (Target End UE) may receive a DCR or LMR from Relay2. UE2 may perform a security establishment with Relay2 if a DCR is received. UE2 may add a route entry to UE1 into its Unicast Routing Table, with Relay2 as a next hop. UE2 may send a DCA or LMA to Relay2, which may include a proactive DNS query for the source IP address. UE2 may request and receive the target IP address (here, IP address of UE2) from Relay2 (acting as a DHCP server or an IPv6 Router). UE2 may receive a DNS Response from Relay2, which includes the source IP address (here, IP address of UE1). UE2 may add a route entry to UE1 into its Unicast IP Routing Table, based on the route entry to UE1in its Unicast Routing Table and an association between the source User Info ID and the received source IP address. UE2 may exchange user plane IP traffic with UE1 via the Unicast IP Routing Tables hop by hop.

In an embodiment, a source End UE may send a proactive DNS query to a target End UE to request a target IP address to be included in a DCA/LMA, and for the target End UE to send a proactive DNS query to the source End UE to request a source IP address to be sent via a DNS Response, while setting up a Unicast IP Routing Table upon receiving a DCA/LMA (with a route entry to the target End UE) and DNS Response (with a route entry to the source End UE) hop by hop for user plane IP traffic routing.

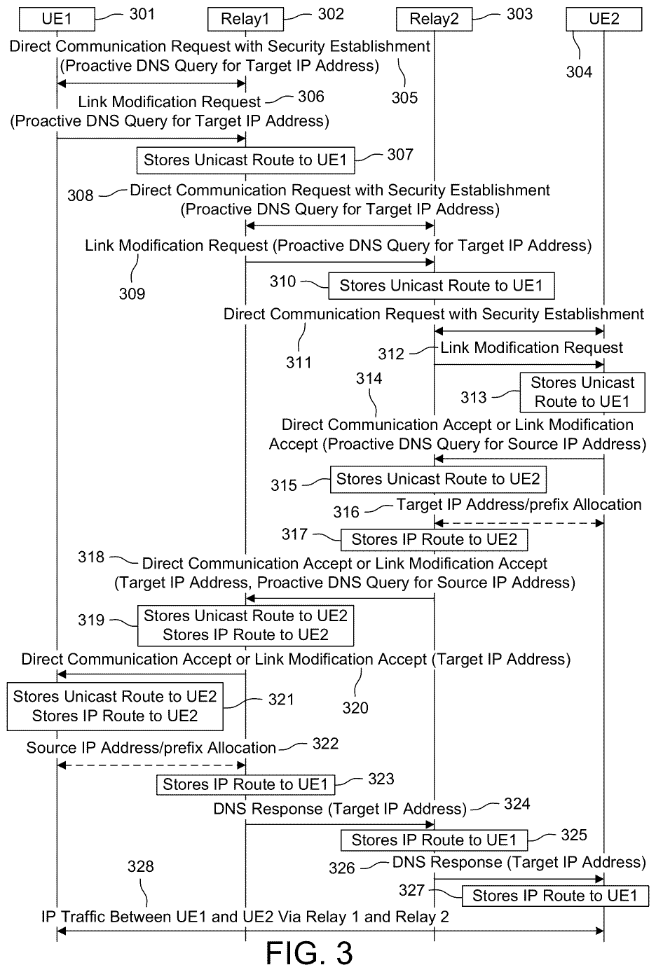

FIG. 3 shows an example procedure for Unicast IP Routing Table setup with proactive DNS query.

Service authorization and provisioning may be performed for UE1 (source End UE), UE2 (target End UE), Relay1, and Relay2. UE1 may have discovered UE2 via a UE-to-UE Relay Discovery (here, [UE1, Relay1, Relay2, UE2]).

UE1 301 (source End UE) may send a Direct Communication Request (DCR) 305 or Link Modification Request (LMR) 306 to Relay1 302 based on the routing information obtained from the UE-to-UE Relay Discovery. If a PC5 connection between UE1 and Relay1 does not exist, UE1 may send a DCR to initiate a PC5 connection setup procedure with Relay1. Otherwise, UE1 may send a LMR to initiate a PC5 connection modification procedure with Relay1. The DCR or LMR sent by UE1 may include, for example, one or more of: information (e.g., User Info ID) of the source End UE (here, UE1), information (e.g., User Info ID) of the target End UE (here, UE2), a proactive DNS query for a target IP address, routing information (e.g., sequence of User Info IDs; here, [User Info ID of Relay1, User Info ID of Relay2]), hop count from the source End UE (here, hop count =0), RSC, and others. A Destination Layer-2 ID of the target End UE (here, UE2) may also be included.

Relay1 302 may receive the DCR 305 or LMR 306 from UE1 301. If the RSC in the received DCR matches any RSC that Relay1 supports, Relay1 may respond by establishing the security with UE1 before adding the route entry 307 to UE1 into its Unicast Routing Table (with matching RSC). If the RSC in the received LMR matches any RSC that Relay1 supports, Relay1 may add a route entry 307 to UE1 into its Unicast Routing Table (with matching RSC). The route entry to UE1 in Relay1's Unicast Routing Table may include, for example, one or more of: a destination: User Info ID of UE1; number of hops to the destination: hop count in the received DCR/LMR plus 1 (here, 1); next hop: directly connected; Destination Layer-2 ID of next hop: Source Layer-2 ID of UE1.

Relay1 302 may send a DCR 308 or LMR 309 to Relay2 303 based on the routing information received in the DCR/LMR from UE1. If a PC5 connection between Relay1 and Relay2 does not exist, Relay1 may send a DCR to initiate a PC5 connection setup procedure with Relay2. Otherwise, Relay1 may send a LMR to initiate a PC5 connection modification procedure with Relay2. The DCR or LMR sent by Relay1 may include, for example, one or more of: information (e.g., User Info ID) of the source End UE (here, UE1), information (e.g., User Info ID) of the sender U2U Relay (here, Relay1), information (e.g., User Info ID) of the target End UE (here, UE2), a proactive DNS query for the target IP address, routing information (e.g., sequence of User Info IDs; here, [User Info ID of Relay2] obtained by removing itself out of the routing information received from UE1), hop count from the source End UE (hop count in the received DCR/LMR plus 1; here, hop count =1), RSC, and others. A Destination Layer-2 ID of the target End UE (here, UE2) may also be included.

Relay2 303 may receive the DCR 308 or LMR 309 from Relay1 302. If the RSC in the received DCR matches any RSC that Relay2 supports, Relay2 may respond by establishing the security with Relay1 before adding the route entry 310 to UE1 into its Unicast Routing Table (with matching RSC). If the RSC in the received LMR matches any RSC that Relay2 supports, Relay2 may add a route entry 310 to UE1 into its Unicast Routing Table (with matching RSC). The route entry to UE1 in Relay2's Unicast Routing Table may include, for example, one or more of: Destination: User Info ID of UE1; number of hops to Destination: hop count in the received DCR/LMR plus 1, here 2; next hop: User Info ID of Relay1 (User Info ID of sender U2U Relay in the received DCR/LMR); Destination Layer-2 ID of Next Hop: Source Layer-2 ID of Relay1.

Relay2 303 may send a DCR 311 or LMR 312 to UE2 (target End UE) 304 based on the routing information received in the DCR/LMR from Relay1 (here, since User Info ID of Relay2 is the only User Info ID in the received routing information, Relay2 is directly connected to the target End UE). If a PC5 connection between Relay2 and UE2 does not exist, Relay2 may send a DCR to initiate a PC5 connection setup procedure with UE2. Otherwise, Relay2 may send a LMR to initiate a PC5 connection modification procedure with UE2. If a PC5 connection between Relay2 and UE1 does not exist, and if the Destination Layer-2 ID of the target End UE is provided in the received DCR/LMR, Relay2 may send a DCR via unicast to initiate the PC5 connection setup procedure with the target End UE (here, UE2). If the Destination Layer-2 ID of target End UE is not provided in the received DCR/LMR, Relay2 may send a DCR via broadcast to initiate the PC5 connection setup procedure with UE2. The DCR or LMR sent by Relay2 may include, for example, one or more of: information (e.g., User Info ID) of the source End UE (here, UE1), information (e.g., User Info ID) of the sender U2U Relay (here, Relay2), information (e.g., User Info ID) of the target End UE (here, UE2), hop count from the source End UE (hop count in the received DCR/LMR plus 1; here, hop count =2), RSC, and others.

UE 2 304 may receive the DCR 311 or LMR 312 from Relay2 303. If the RSC in the received DCR matches any RSC that UE2 supports, UE2 may respond by establishing the security with Relay2 before adding the route entry 313 to UE1 into its Unicast Routing Table. If the RSC in the received LMR matches any RSC that UE2 supports, UE2 may add a route entry 313 to UE1 into its Unicast Routing Table (with matching RSC). The route entry to UE1 in UE2's Unicast Routing Table may include, for example, one or more of: Destination: User Info ID of UE1; number of hops to Destination: hop count in the received DCR/LMR plus 1, here 3); next hop: User Info ID of Relay2 (User Info ID of sender U2U Relay in the received DCR/LMR); Destination Layer-2 ID of Next Hop: Source Layer-2 ID of Relay2.

UE2 304 may send a Direct Communication Accept (DCA) or Link Modification Accept (LMA) 314 to Relay2 303 based on the next hop information of the route entry to UE1 (source End UE) in the Unicast Routing Table (with matching RSC). If a PC5 connection between UE2 and Relay2 does not exist, UE2 may send a DCA to Relay2. Otherwise, UE1 may send a LMA to Relay2. The DCA/LMA sent by UE1 may include, for example, one or more of: information (e.g., User Info ID) of the source End UE (here, UE1), a proactive DNS query for a source IP address, information (e.g., User Info ID) of the target End UE (here, UE2), hop count from the target End UE (here, hop count =0), RSC, and others.

Relay2 303 may receive the DCA or LMA 314 from UE 2 304. Relay2 may add a route entry 315 to UE 2 into its Unicast Routing Table (with matching RSC). The route entry to UE2 in Relay2's Unicast Routing Table may include, for example, one or more of: Destination: User Info ID of UE2; number of hops to Destination: hop count in the received DCA/LMA plus 1, here 1); next hop: directly connected; Destination Layer-2 ID of Next Hop: Source Layer-2 ID of UE2.

UE2 304 may request the (target) IP address 316 from Relay2 (acting as a DHCP server or an IPv6 Router) 303. After receiving the assigned IP address from Relay2, UE2 may store the assigned target IP address for Layer-3 IP communication.

After the completion of the IP address assignment procedure with UE2, Relay2 may store an association of the target User Info ID and the assigned target IP address (here, IP address of UE2) for DNS lookup and IP traffic routing. Relay2 may add a route entry 317 to UE2 into its Unicast IP Routing Table (with matching RSC), based on the route entry to UE2 in its Unicast Routing Table and the association between target User Info ID and target IP address. The route entry to UE2 in Relay2's Unicast IP Routing Table may include, for example, one or more of: Destination: IP address of UE2; number of hops to Destination: 1 (directly connected); Destination Layer-2 ID of Next Hop: Source Layer-2 ID of UE2.

Relay2 303 may send a DCA or LMA 318 to Relay1 302 based on the next hop information to UE1 in its Unicast Routing Table (with matching RSC). If a PC5 connection between Relay2 and Relay1 does not exist, Relay2 may send a DCA to Relay1. Otherwise, Relay2 may send a LMA to Relay1. If a proactive DNS query for a target IP address is included in the received DCR/LMR from Relay1, and a DNS entry for UE1 is not available, and a target IP address is not included in the received DCA/LMA from UE2, Relay2 may wait for the completion of the (e.g., DHCP) IP address assignment procedure with UE2 before sending out the DCA/LMA to Relay1. A timer may be used to limit the amount of time Relay2 waits for the completion of the (e.g., DHCP) IP address assignment procedure with UE2 to include the target IP address in the DCA/LMA sending to Relay1. The DCA/LMA sent by Relay2 may include, for example, one or more of: information (e.g., User Info ID) of the source End UE (here, UE1), a proactive DNS query for the source IP address, information (e.g., User Info ID) of the target End UE (here, UE2), the target IP address (here, IP address of UE2), information (e.g., User Info ID) of the sender U2U Relay (here, Relay2), hop count from the target End UE (hop count in the received DCA/LMA plus 1; here, hop count =1), RSC, and others.

Relay1 302 may receive the DCA or LMA 318 from Relay2 303. Relay1 may add a route entry 319 to UE1 into its Unicast Routing Table (with matching RSC). The route entry to UE1 in Relay1's Unicast Routing Table may include, for example, one or more of: Destination: User Info ID of UE2; number of hops to Destination: hop count in the received DCA/LMA plus 1; here 2; next hop: User Info ID of Relay2 (User Info ID of sender U2U Relay in the received DCA/LMA); and Destination Layer-2 ID of Next Hop: Source Layer-2 ID of Relay2. If the target IP address (here, IP address of UE2) is included in the received DCA/LMA, Relay1 may store an association of the target User Info ID and target IP address for DNS lookup and IP traffic routing and may add a route entry to UE2 into its Unicast IP Routing Table (with matching RSC) based on the route entry to UE2 in its Unicast Routing Table and the association between the target User Info ID and the received target IP address. The route entry to UE2 in Relay1's Unicast IP Routing Table may include, for example, one or more of: Destination: IP address of UE2; number of hops to Destination: 2; Destination Layer-2 ID of Next Hop: Source Layer-2 ID of Relay2.

Relay1 302 may send a DCA or LMA 320 to UE1 301 based on the next hop (Destination Layer-2 ID) information in the Unicast Routing Table (with matching RSC). If a PC5 connection between Relay1 and UE1 does not exist, Relay1 may send a DCA to UE1. Otherwise, Relay1 may send a LMA to UE1. The DCA/LMA sent by Relay1 may include, for example, one or more of: information (e.g., User Info ID) of the source End UE (here, UE1), information (e.g., User Info ID) of the target End UE (here, UE2), the target IP address (here, IP address of UE2), information (e.g., User Info ID) of the sender U2U Relay (here, Relay1), hop count from the target End UE (hop count in the received DCA/LMA plus 1; here, hop count =2), RSC, and others.

UE1 301 may receive the DCA or LMA 320 from Relay1 302. UE1 may add a route entry 321 to UE 2 into its Unicast Routing Table (with matching RSC). The route entry to UE2 in UE1's Unicast Routing Table may include, for example, one or more of: Destination: User Info ID of UE2; number of hops to Destination: hop count in the received DCA/LMA plus 1; here 3; next hop: User Info ID of Relay1 (User Info ID of sender U2U Relay in the received DCA/LMA); Destination Layer-2 ID of Next Hop: Source Layer-2 ID of Relay1. If the target IP address (here, IP address of UE2) is included in the received DCA/LMA, UE1 may store an association of the target User Info ID and the target IP address for IP traffic routing and may add a route entry to UE1 into its Unicast IP Routing Table (with matching RSC) based on the route entry to UE2 in its Unicast Routing Table and the association between target User Info ID and the received target IP address. The route entry to UE2 in UE1's Unicast IP Routing Table may include, for example, one or more of: Destination: IP address of UE2; number of hops to Destination: here 3; Destination Layer-2 ID of Next Hop: Source Layer-2 ID of Relay1.

UE1 301 may request a (source) IP address 322 from Relay1 302 (acting as a DHCP server or an IPv6 Router). After receiving the assigned IP addresses from Relay1, UE1 may store the assigned source IP address for Layer-3 IP communication.

Relay1 302 (acting as a DHCP server or an IPv6 Router) may assign an IP address 322 to UE1. Relay1 may store an association of the source User Info ID and the assigned source IP address (here, IP address of UE1) for DNS lookup and IP traffic routing and may add a route entry to UE1 into its Unicast IP Routing Table (with matching RSC), based on the route entry to UE1 in its Unicast Routing Table (see 307) and the association between source User Info ID and the assigned source IP address. The route entry to UE1 in Relay1's Unicast IP Routing Table may include, for example, one or more of: Destination: IP address of UE1; number of hops to Destination: 1 (directly connected); Destination Layer-2 ID of Next Hop: Source Layer-2 ID of UE1.

If a proactive DNS query for source IP address is included in the received DCA/LMA from Relay2, and the source IP address is not provided during security establishment with UE1, Relay1 may send a DNS Response message 324 to UE2, via Relay2.Relay1 may wait for the completion of the (e.g., DHCP) IP address assignment procedure with UE1 to send out the DNS Response to the target End UE (here, UE2) via Relay2, which may include the assigned source IP address (here, IP address of UE1), based on the next hop information (here, Relay2) to the target End UE in the Unicast Routing Table (with matching RSC). A timer may be used to limit the amount of time Relay1 waits for the completion of the (e.g., DHCP) IP address assignment procedure with UE1 to send the DNS Response.

Relay2 303 may receive the DNS Response 324 from Relay 1 302. Relay2 may store an association of the source User Info ID and the received source IP address (here, IP address of UE1) for DNS lookup and IP traffic routing and may add a route entry 325 to UE1 into its Unicast IP Routing Table (with matching RSC), based on the route entry to UE1 in its Unicast Routing Table (see 310) and the association between source User Info ID and the received source IP address. The route entry to UE1 in Relay2's Unicast IP Routing Table may include, for example, one or more of: Destination: IP address of UE1; number of hops to Destination: here 2; Destination Layer-2 ID of Next Hop: Source Layer-2 ID of Relay1.

Relay2 303 may send a DNS Response 326 to UE2 304. The DNS Response may include the source IP address (here, IP address of UE1), and may be sent to the target End UE (here, UE2) based on the next hop information (here, source Layer-2 ID of UE2) to the target End UE in the Unicast Routing Table (with matching RSC).

UE2 304 may receive the DNS Response 326 from Relay2 303. UE 2 may store an association of the source User Info ID and the received source IP address (here, IP address of UE1) for IP traffic routing and may add a route entry 327 to UE1 into its Unicast IP Routing Table (with matching RSC), based on the route entry to UE 1 in its Unicast Routing Table (see 316) and the association between source User Info ID and the received source IP address. The route entry to UE1 in UE2's Unicast IP Routing Table may include, for example, one or more of: Destination: IP address of UE1; number of hops to Destination: here 3; Destination Layer-2 ID of Next Hop: Source Layer-2 ID of Relay2.

UE1 301 (source End UE) may communicate 328 (e.g. IP traffic) with UE2 304 (target End UE) in the user plane via the Unicast IP Routing Tables hop by hop, via Relay1 and Relay2 and vice versa.

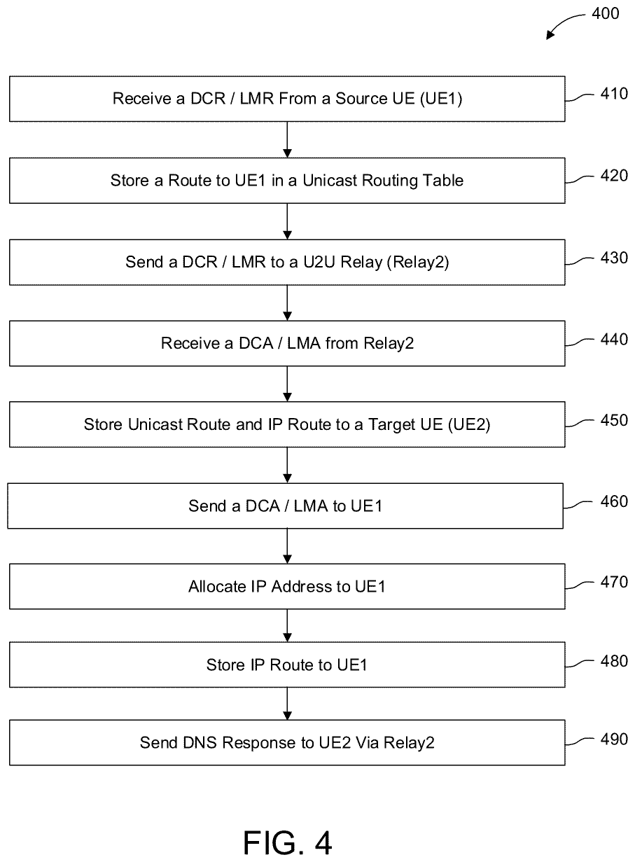

FIG. 4 shows an example procedure 400 for a U2U relay UE (Relay1) for Unicast IP Routing Table setup with proactive DNS query.

A first U2U relay (Relay1) may receive a Direct Communication Request (DCR) or Link Modification Request (LMR) from a first source End UE (UE1) 410. If a PC5 connection between UE1 and Relay1 does not exist, Relay1 may receive a DCR to initiate a PC5 connection setup procedure with UE1. Otherwise, Relay1 may receive a LMR to initiate a PC5 connection modification procedure with UE1. The DCR or LMR received by Relay1 may include, for example, one or more of: information (e.g., User Info ID) of the source End UE (here, UE1), information (e.g., User Info ID) of a target End UE (here, UE2), a proactive DNS query for a target IP address, routing information (e.g., sequence of User Info IDs; here, [User Info ID of Relay1, User Info ID of Relay2]), hop count from the source End UE (here, hop count =0), RSC, and others. A Destination Layer-2 ID of the target End UE (here, UE2) may also be included.

Relay1 may store or add a route to UE 1 in a Unicast Routing Table 420. If the RSC in the received DCR matches any RSC that Relay1 supports, Relay1 may respond by establishing the security with UE1 before adding the route entry to UE1 into its Unicast Routing Table (with matching RSC). If the RSC in the received LMR matches any RSC that Relay1 supports, Relay1 may add the route entry to UE1 into its Unicast Routing Table (with matching RSC). The route entry to UE1 in Relay1's Unicast Routing Table may include, for example, one or more of: a destination: User Info ID of UE1; number of hops to the destination: hop count in the received DCR/LMR plus 1 (here, 1); next hop: directly connected; Destination Layer-2 ID of the next hop: Source Layer-2 ID of UE1.

Relay1 may send a DCR or LMR to a second U2U relay (Relay2) 430 based on the routing information received in the DCR/LMR from UE1. If a PC5 connection between Relay1 and Relay2 does not exist, Relay1 may send a DCR to initiate a PC5 connection setup procedure with Relay2. Otherwise, Relay1 may send a LMR to initiate a PC5 connection modification procedure with Relay2. The DCR or LMR sent by Relay1 may include, for example, one or more of: information (e.g., User Info ID) of the source End UE (here, UE1), information (e.g., User Info ID) of the sender U2U Relay (here, Relay1), information (e.g., User Info ID) of the target End UE (here, UE2), a proactive DNS query for the target IP address, routing information (e.g., sequence of User Info IDs; here, [User Info ID of Relay2] obtained by removing itself out of the routing information received from UE1]), hop count from the source End UE (hop count in the received DCR/LMR plus 1; here, hop count =1), RSC, and others. A Destination Layer-2 ID of the target End UE (here, UE2) may also be included.

Relay1 may receive a DCA or LMA from Relay2 440. If a PC5 connection between Relay2 and Relay1 does not exist, Relay1 may receive a DCA from Relay2. Otherwise, Relay1 may receive a LMA from Relay2. The DCA/LMA received from Relay2 may include, for example, one or more of: information (e.g., User Info ID) of the source End UE (here, UE1), a proactive DNS query for the source IP address, information (e.g., User Info ID) of the target End UE (here, UE2), the target IP address (here, IP address of UE2), information (e.g., User Info ID) of the sender U2U Relay (here, Relay2), hop count from the target End UE (here, hop count =1), RSC, and others.

Relay1 may add a route entry to UE 2 into its Unicast Routing Table (with matching RSC) 450.The route entry to UE2 in Relay1's Unicast Routing Table may include, for example, one or more of: Destination: User Info ID of UE2; number of hops to Destination: hop count in the received DCA/LMA plus 1; here 2; next hop: User Info ID of Relay2 (User Info ID of sender U2U Relay in the received DCA/LMA); and Destination Layer-2 ID of Next Hop: Source Layer-2 ID of Relay2. If the target IP address (here, IP address of UE2) is included in the received DCA/LMA, Relay1 may store an association of the target User Info ID and target IP address for DNS lookup and IP traffic routing and may add a route entry to UE2 into its Unicast IP Routing Table (with matching RSC) 450 based on the route entry to UE2 in its Unicast Routing Table and the association between the target User Info ID and the received target IP address. The route entry to UE2 in Relay1's Unicast IP Routing Table may include, for example, one or more of: Destination: IP address of UE2; number of hops to Destination: 2; Destination Layer-2 ID of Next Hop: Source Layer-2 ID of Relay2.

Relay1 may send a DCA or LMA to UE1 460. Relay1 may send the DCA/LMA based on the next hop (Destination Layer-2 ID) information in the Unicast Routing Table (with matching RSC). If a PC5 connection between Relay1 and UE1 does not exist, Relay1 may send a DCA to UE1. Otherwise, Relay1 may send a LMA to UE1. The DCA/LMA sent by Relay1 may include, for example, one or more of: information (e.g., User Info ID) of the source End UE (here, UE1), information (e.g., User Info ID) of the target End UE (here, UE2), the target IP address (here, IP address of UE2), information (e.g., User Info ID) of the sender U2U Relay (here, Relay1), hop count from the target End UE (hop count in the received DCA/LMA plus 1; here, hop count =2), RSC, and others.

Relay1 may allocate an IP address to UE1 470. Relay1 may receive a request for a (source) IP address from UE1. Relay1 assign an IP address, acting as a DHCP server or an IPv6 Router. Relay1 may send the assigned IP addresses to UE1.

Relay1 may store an IP route to UE1 480. Relay1 may store an association of the source (UE1) User Info ID and the assigned source IP address (here, IP address of UE1) for DNS lookup and IP traffic routing and may add a route entry to UE1 into its Unicast IP Routing Table (with matching RSC), based on the route entry to UE1 in its Unicast Routing Table and the association between the source User Info ID and the assigned source IP address. The route entry to UE1 in Relay1's Unicast IP Routing Table may include, for example, one or more of: Destination: IP address of UE1; number of hops to Destination: 1 (directly connected); Destination Layer-2 ID of Next Hop: Source Layer-2 ID of UE1.

Relay1 may send a DNS Response message to UE 2 via Relay2 490. Relay1 may send the DNS response if a proactive DNS query for a source IP address was included in the received DCA/LMA from Relay2, and the source IP address was not provided during security establishment with UE1. Relay1 may wait for the completion of the (e.g., DHCP) IP address assignment procedure with UE1 to send out the DNS Response to the target End UE (here, UE2) via Relay2, which may include the assigned source IP address (here, IP address of UE1), based on the next hop information (here, Relay2) to the target End UE in the Unicast Routing Table (with matching RSC). A timer may be used to limit the amount of time Relay1 waits for the completion of the (e.g., DHCP) IP address assignment procedure with UE1 to send the DNS Response.

In an embodiment, a Unicast IP Routing Table may be set up with delegate IP address assignment. A source End UE (UE1) may include a delegate IP address assignment indication in a DCR/LMR. A Unicast Routing Table may be updated hop by hop to include a route entry to UE1. A U2U relay (Relay2) may include a source IP address and a target IP address in a DCA/LMA. Unicast Routing Tables may be updated hop by hop to include a route entry to UE2 (target End UE) on each hop. Unicast IP Routing Tables may be updated hop by hop to include a route entry to UE1 and a route entry to UE2 on each hop.

UE1 (Source End UE) may send a DCR or LMR to Relay1, which may include a delegate IP address assignment indication and routing information obtained from UE-to-UE Relay Discovery. UE1 may receive a DCA/LMA from Relay1, including source and target IP addresses. UE1 may add a route entry to UE1 into its Unicast Routing Table. UE1 may add a route entry to UE1 into its Unicast IP Routing Table based on the route entry to UE1 in its Unicast Routing Table and an association between the target User Info ID and the received target IP address. UE1 may exchange user plane IP traffic with UE1 via the Unicast IP Routing Tables hop by hop.

Relay1 (U2U Relay UE) may receive a DCR or LMR from UE1. Relay1 may perform a security establishment with UE1 if a DCR is received. Relay1 may add a route entry to UE1 into its Unicast Routing Table. Relay1 may send a DCR or LMR to Relay2, which may include a delegate IP address assignment indication and routing information (e.g., obtained by removing itself out of the routing information received from UE1). Relay1 may receive a DCA/LMA from Relay2, including source and target IP addresses. Relay1 may add a route entry to UE1 into its Unicast Routing Table. Relay1 may add a route entry to UE1/UE1 into its Unicast IP Routing Table based on the route entry to UE1/UE1 in its Unicast Routing Table and an association between the source/target User Info ID and the received source/target IP address. Relay1 may send a DCA or LMA to UE1, which may include a source IP address (here, IP address of UE1) and a target IP address (here, IP address of UE2).

Relay2 (U2U Relay UE) may receive a DCR or LMR from Relay1. Relay2 may perform a security establishment with Relay1 if a DCR is received. Relay2 may add a route entry to UE1 into its Unicast Routing Table, with Relay1 as a next hop. Relay2 may send a DCR or LMR to UE2, which may include a delegate IP address assignment indication. Relay2 may receive a DCA/LMA from UE2. Relay2 may add a route entry to UE2 into its Unicast Routing Table. Relay2 may assign an IP addresses (acting as a DHCP server or an IPv6 Router) for the source/target End UEs (here, UE1/UE2). Relay2 may add a route entry to UE1/UE1 into its Unicast IP Routing Table, based on the route entry to UE1/UE1 in its Unicast Routing Table and an association between the source/target User Info ID and the assigned source/target IP address. Relay2 may send a DCA or LMA to Relay1, which may include a source IP address (here, IP address of UE1) and a target IP address (here, IP address of UE2).

UE1 (Target End UE) may receive a DCR or LMR from Relay2. UE2 may perform a security establishment with Relay2 if a DCR is received. UE2 may add a route entry to UE1 into its Unicast Routing Table, with Relay2 as a next hop. UE2 may send a DCA or LMA to Relay2. UE1 may request and receive an IP address for the target End UE (here, UE2) from Relay2 (acting as a DHCP server or an IPv6 Router). UE2 may request and receive an IP address for the source End UE (here, UE1) from Relay2 (acting as a DHCP server or an IPv6 Router), if a delegate IP address assignment indication is included in the received DCR/LMR message from Relay2. UE2 may add a route entry to UE1 into its Unicast IP Routing Table, based on the route entry to UE1 in its Unicast Routing Table and an association between the source User Info ID and the assigned source IP address. UE2 may exchange user plane IP traffic with UE1 via the Unicast IP Routing Tables hop by hop.

After Relay2 assigns an IP address for UE1, the ownership of this IP address may be transferred to Relay1 for future IP address management. The DCA/LMA sent from Relay2 to Relay1 and the DCA/LMA sent from Relay1 to UE1 may include the User Info ID of the Relay2 as the delegate U2U Relay for source IP address assignment. After Relay1 receives the source IP address from Relay2 in the DCA/LMA, Relay1 may send an acknowledge message to Relay2 to complete the transfer of the management ownership of the corresponding IP address.

In an embodiment, a source End UE may delegate a target End UE to request a source IP address from a target End UE's immediate U2U Relay acting as a DHCP server (or an IPv6 Router) and report the source IP address back to the source End UE in DCA/LMA, while setting up Unicast IP Routing Table upon receiving the DCA/LMA (with a route entry to the target End UE and a route entry to the source End UE) hop by hop during the link establishment procedure for user plane IP traffic routing.

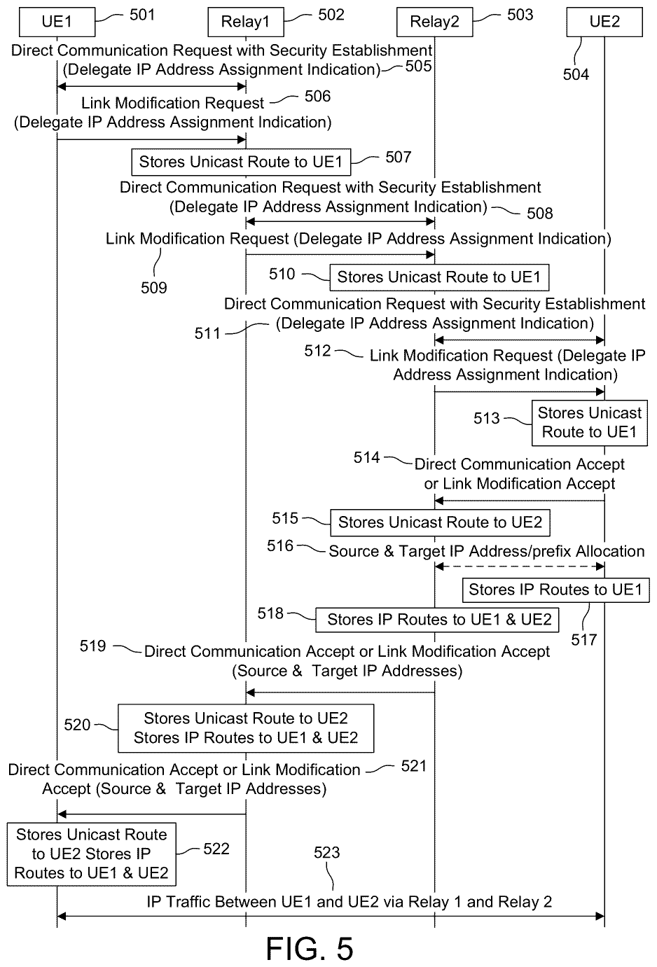

FIG. 5 shows an example procedure for Unicast IP Routing Table setup with delegate IP address assignment.

Service authorization and provisioning may be performed for UE1 501 (source End UE), UE2 502 (target End UE), Relay1 503, and Relay2 504. UE1 may have discovered UE2 via UE-to-UE Relay Discovery (here, [UE1, Relay1, Relay2, UE2]).

UE1 501 (source End UE) may send a Direct Communication Request (DCR) 505 or Link Modification Request (LMR) 506 to Relay1 502 based on the routing information obtained from UE-to-UE Relay Discovery. If a PC5 connection between UE1 and Relay1 does not exist, UE1 may send a DCR to initiate a PC5 connection setup procedure with Relay1. Otherwise, UE1 may send a LMR to initiate a PC5 connection modification procedure with Relay1. The DCR or LMR sent by UE1 may include, for example, one or more of: information (e.g., User Info ID) of a source End UE (here, UE1), a delegate IP address assignment indication, information (e.g., User Info ID) of a target End UE (here, UE2), routing information (e.g., sequence of User Info IDs; here, [User Info ID of Relay1, User Info ID of Relay2]), hop count from the source End UE (here, hop count =0), RSC, and others. Destination Layer-2 ID of the target End UE (here, UE2) may also be included.

Relay1 502 may receive the DCR 505 or LMR 506 from UE1 501. If the RSC in the received DCR matches any RSC that Relay1 supports, Relay1 responds by establishing the security with UE1 before adding the route entry to UE1 into its Unicast Routing Table (with matching RSC). If the RSC in the received LMR matches any RSC that Relay1 supports, Relay1 may add a route entry 507 to UE1 into its Unicast Routing Table (with matching RSC). The route entry to UE1 in Relay1's Unicast Routing Table may include, for example, one or more of: Destination: User Info ID of UE1; number of hops to Destination: hop count in the received DCR/LMR plus 1,here 1; next hop: directly connected; Destination Layer-2 ID of Next Hop: Source Layer-2 ID of UE1.

Relay1 502 may send a DCR 508 or LMR 509 to Relay2 505 based on the routing information received in the DCR/LMR from UE1. If a PC5 connection between Relay1 and Relay2 does not exist, Relay1 may send a DCR to initiate a PC5 connection setup procedure with Relay2. Otherwise, Relay1 may send a LMR to initiate a PC5 connection modification procedure with Relay2. The DCR or LMR sent by Relay1 may include, for example, one or more of: information (e.g., User Info ID) of the source End UE (here, UE1), a delegate IP address assignment indication, information (e.g., User Info ID) of the sender U2U Relay (here, Relay1), information (e.g., User Info ID) of the target End UE (here, UE2), routing information (e.g., sequence of User Info IDs; here, [User Info ID of Relay2] obtained by removing itself out of the routing information received from UE1) obtained from UE-to-UE Relay Discovery, hop count from the source End UE (hop count in the received DCR/LMR plus 1; here, hop count =1), RSC, and others. Destination Layer-2 ID of target End UE (here, UE2) may also be included.

Relay2 503 may receive the DCR 508 or LMR 509 from Relay1 502. If the RSC in the received DCR matches any RSC that Relay2 supports, Relay2 may respond by establishing the security with Relay1 before adding the route entry to UE1 into its Unicast Routing Table (with matching RSC). If the RSC in the received LMR matches any RSC that Relay2 supports, Relay2 may add a route entry 510 to UE1 into its Unicast Routing Table (with matching RSC). The route entry to UE1 in Relay2's Unicast Routing Table may include, for example, one or more of: Destination: User Info ID of UE1; number of hops to Destination: hop count in the received DCR/LMR plus 1, here 2; next hop: User Info ID of Relay1 (User Info ID of sender U2U Relay in the received DCR/LMR); Destination Layer-2 ID of Next Hop: Source Layer-2 ID of Relay1.

Relay2 503 may send a DCR 511 or LMR 512 to UE2 504 (target End UE) based on the routing information received in the DCR/LMR from Relay1 (here, since User Info ID of Relay2 is the only User Info ID in the received routing information, Relay2 is directly connected to the target End UE). If a PC5 connection between Relay2 and UE2 does not exist, Relay2 may send a DCR to initiate a PC5 connection setup procedure with UE2. Otherwise, Relay2 may send a LMR to initiate a PC5 connection modification procedure with UE2. If a PC5 connection between Relay2 and UE1 does not exist, and if the Destination Layer-2 ID of target End UE is provided in the received DCR/LMR, Relay2 may send a DCR via unicast to initiate the PC5 connection setup procedure with the target End UE (here, UE2). If the Destination Layer-2 ID of target End UE is not provided in the received DCR/LMR, Relay2 may send a DCR via broadcast to initiate the PC5 connection setup procedure with UE2. The DCR or LMR sent by Relay2 may include, for example, one or more of: information (e.g., User Info ID) of the source End UE (here, UE1), a delegate IP address assignment indication, information (e.g., User Info ID) of sender U2U Relay (here, Relay2), information (e.g., User Info ID) of target End UE (here, UE2), hop count from the source End UE (hop count in the received DCR/LMR plus 1; here, hop count =2), RSC, and others.

UE2 504 may receive the DCR 511 or LMR 512 from Relay2 503. If the RSC in the received DCR matches any RSC that UE2 supports, UE2 may respond by establishing the security with Relay2 before adding the route entry to UE1 into its Unicast Routing Table. If the RSC in the received LMR matches any RSC that UE2 supports, UE2 may add a route entry 513 to UE1 into its Unicast Routing Table (with matching RSC). The route entry to UE1 in UE2's Unicast Routing Table may include, for example, one or more of: Destination: User Info ID of UE1; number of hops to Destination: hop count in the received DCR/LMR plus 1, here 3; next hop: User Info ID of Relay2 (User Info ID of sender U2U Relay in the received DCR/LMR); Destination Layer-2 ID of Next Hop: Source Layer-2 ID of Relay2.

UE2 504 may send a Direct Communication Accept (DCA) or Link Modification Accept (LMA) 514 to Relay2 503 based on the next hop information of the route entry to UE1 (source End UE) in the Unicast Routing Table (with matching RSC). If a PC5 connection between UE2 and Relay2 does not exist, UE2 may send a DCA to Relay2. Otherwise, UE1 may send a LMA to Relay2. The DCA/LMA sent by UE1 may include, for example, one or more of: information (e.g., User Info ID) of the source End UE (here, UE1), information (e.g., User Info ID) of the target End UE (here, UE2), hop count from the target End UE (here, hop count =0), RSC, and others.

Relay2 503 may receive the DCA or LMA 514 from UE2 504. Relay2 may add a route entry 515 to UE2 into its Unicast Routing Table (with matching RSC). The route entry to UE1 in Relay2's Unicast Routing Table may include, for example, one or more of: Destination: User Info ID of UE2; number of hops to Destination: hop count in the received DCA/LMA plus 1; here 1; next hop: directly connected; Destination Layer-2 ID of Next Hop: Source Layer-2 ID of UE2.

UE2 504 may request a (target) IP address 516 from Relay2 503 (acting as a DHCP server or an IPv6 Router). If a delegate IP address assignment indication is included in the received DCR/LMR from Relay2, UE2 may also request a (source) IP address for the source End UE (here, UE1) from Relay2. After receiving the assigned target IP address from Relay2 (here, IP address of UE2), UE2 may store 517 the assigned target IP address for Layer-3 IP communication. After receiving the assigned source IP address (here, IP address of UE1) from Relay2, UE2 may store an association of source User Info ID and source IP address for IP traffic routing and add a route entry to UE1 into its Unicast IP Routing Table (with matching RSC), based on the route entry to UE1 in its Unicast Routing Table (see 513) and the association between source User Info ID and the assigned source IP address. The route entry to UE1 in UE2's Unicast IP Routing Table may include, for example, one or more of: Destination: IP address of UE1; number of hops to Destination: here 3; Destination Layer-2 ID of Next Hop: Source Layer-2 ID of Relay2.

After Relay2 completes the IP address assignment procedure with UE2 for source and target IP addresses, Relay2 may store an association of target User Info ID and target IP address for DNS lookup and IP traffic routing and add a route entry 518 to UE2 into its Unicast IP Routing Table (with matching RSC), based on the route entry to UE2 in its Unicast Routing Table and the association between the target User Info ID and the assigned target IP address. The route entry to UE2 in Relay2's Unicast IP Routing Table may include, for example, one or more of: Destination: IP address of UE2; number of hops to Destination: 1 (directly connected); Destination Layer-2 ID of Next Hop: Source Layer-2 ID of UE2. Relay2 may store an association of source User Info ID and source IP address for DNS lookup and IP traffic routing and add a route entry 518 to UE1 into its Unicast IP Routing Table (with matching RSC), based on the route entry to UE1 in its Unicast Routing Table (see 510) and the association between source User Info ID and the assigned source IP address. The route entry to UE1 in Relay2's Unicast IP Routing Table may include, for example, one or more of: Destination: IP address of UE1; number of hops to Destination: here 2; Destination Layer-2 ID of Next Hop: Source Layer-2 ID of Relay1.

Relay2 503 may send a DCA or LMA 519 to Relay1 502 based on the next hop information to UE1 in its Unicast Routing Table (with matching RSC). If a PC5 connection between Relay2 and Relay1 does not exist, Relay2 may send a DCA to Relay1. Otherwise, Relay2 may send a LMA to Relay1. If a delegate IP address assignment indication is included in the received DCR/LMR from Relay1, Relay2 may wait for the completion of the (e.g., DHCP) IP address assignment procedure with UE2 (for both source IP address and target IP address) before sending out the DCA/LMA to Relay1.

A timer may be used to limit the amount of time Relay2 waits for the completion of the (e.g., DHCP) IP address assignment procedure with UE2 to include the source and target IP addresses in the DCA/LMA sending to Relay1.

The DCA/LMA sent by Relay2 may include, for example, one or more of: information (e.g., User Info ID) of the source End UE (here, UE1), source IP address (here, IP address of UE1), information (e.g., User Info ID) of the target End UE (here, UE2), target IP address (here, IP address of UE2), information (e.g., User Info ID) of the sender U2U Relay (here, Relay2), hop count from the target End UE (hop count in the received DCA/LMA plus 1;here, hop count =1), RSC, and others.

Relay1 502 may receive the DCA or LMA 519 from Relay2 503. Relay1 may add a route entry 520 to UE1 into its Unicast Routing Table (with matching RSC). The route entry to UE2 in Relay1's Unicast Routing Table may include, for example, one or more of: Destination: User Info ID of UE2; number of hops to Destination: hop count in the received DCA/LMA plus 1, here 2; Next Hop: User Info ID of Relay2 (User Info ID of sender U2U Relay in the received DCA/LMA); Destination Layer-2 ID of Next Hop: Source Layer-2 ID of Relay2. If the target IP address (here, IP address of UE2) is included in the received DCA/LMA, Relay1 may store an association of the target User Info ID and target IP address for DNS lookup and IP traffic routing and add a route entry 520 to UE1 into its Unicast IP Routing Table (with matching RSC) based on the route entry to UE2 in its Unicast Routing Table and the association between target User Info ID and the received target IP address. The route entry to UE2 in Relay1's Unicast IP Routing Table may include, for example, one or more of: Destination: IP address of UE2; number of hops to Destination: here 2; Destination Layer-2 ID of Next Hop: Source Layer-2 ID of Relay2. If the source IP address (here, IP address of UE1) is included in the received DCA/LMA, Relay1 may store an association of the source User Info ID and source IP address for DNS lookup and IP traffic routing and add a route entry 520 to UE1 into its Unicast IP Routing Table (with matching RSC), based on the route entry to UE1 in its Unicast Routing Table (see 507) and the association between source User Info ID and the received source IP address. The route entry to the source End UE (here, UE1) in Relay1's Unicast IP Routing Table may include, for example, one or more of: Destination: IP address of UE1; number of hops to Destination: 1 (directly connected); Destination Layer-2 ID of Next Hop: Source Layer-2 ID of UE1;

Relay1 502 may send a DCA or LMA 521 to UE1 501 based on the next hop (Destination Layer-2 ID) information in the Unicast Routing Table (with matching RSC). If a PC5 connection between Relay1 and UE1 does not exist, Relay1 may send a DCA to UE1. Otherwise, Relay1 may send a LMA to UE1. The DCA/LMA sent by Relay1 may include, for example, one or more of: information (e.g., User Info ID) of the source End UE (here, UE1), source IP address (here, IP address of UE1), information (e.g., User Info ID) of the target End UE (here, UE2), target IP address (here, IP address of UE2), information (e.g., User Info ID) of the sender U2U Relay (here, Relay1), hop count from the target End UE (hop count in the received DCA/LMA plus 1; here, hop count =2), RSC, and others.

UE1 501 may receive the DCA or LMA 521 from Relay1 502. UE1 may add a route entry 522 to UE2 into its Unicast Routing Table (with matching RSC). The route entry to UE2 in UE1's Unicast Routing Table may include, for example, one or more of: Destination: User Info ID of UE2; number of hops to Destination: hop count in the received DCA/LMA plus 1, here 3; Next Hop: User Info ID of Relay1 (User Info ID of sender U2U Relay in the received DCA/LMA); Destination Layer-2 ID of Next Hop: Source Layer-2 ID of Relay1.

If the target IP address (here, IP address of UE2) is included in the received DCA/LMA, UE1 may store an association of the target User Info ID and target IP address for IP traffic routing and add a route entry 522 to UE2 into its Unicast IP Routing Table (with matching RSC) based on the route entry to UE2 in its Unicast Routing Table and the association between target User Info ID and the received target IP address. The route entry to UE2 in UE1's Unicast IP Routing Table may include, for example, one or more of: Destination: IP address of UE2; number of hops to Destination: 3; Destination Layer-2 ID of Next Hop: Source Layer-2 ID of Relay1. If the source IP address (here, IP address of UE1) is included in the received DCA/LMA, UE1 may store the received source IP address for Layer-3 IP communication.

UE1 501 (source End UE) may communicate 523 (e.g. IP traffic) with UE2 504 (target End UE) in the user plane via the Unicast IP Routing Tables hop by hop and vice versa.

The DCA/LMA sent from Relay2 to UE1 may include the User Info ID of Relay2 as the delegate IP address assignment U2U Relay for future IP address management. In addition, after Relay2 assigns the IP address for UE1, the ownership of this IP address may be transferred to Relay1 for future IP address management. The DCA/LMA sent from Relay2 to Relay1 may include the User Info ID of the Relay2 as the delegate IP address assignment U2U Relay for source IP address. After Relay1 receives the source IP address from Relay2 in DCA/LMA, Relay1 may send an acknowledge message to Relay2 to complete the transfer of the management ownership of the corresponding IP address.

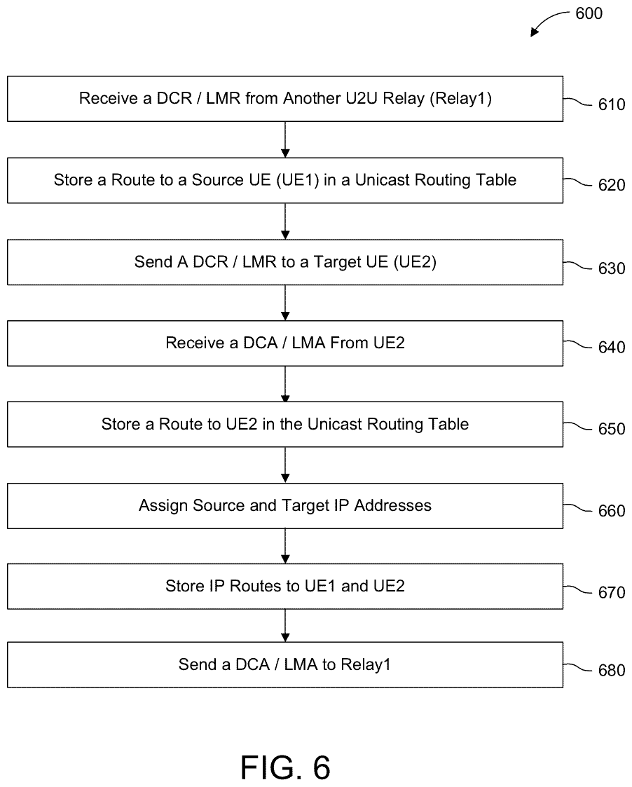

FIG. 6 shows an example procedure 600 for a U2U relay UE (Relay2) for Unicast IP Routing Table setup with delegate IP address assignment.

A U2U relay (Relay2) may receive a DCR or LMR from another U2U relay (Relay1) 610. If a PC5 connection between Relay1 and Relay2 does not exist, Relay2 may receive a DCR to initiate a PC5 connection setup procedure with Relay1. Otherwise, Relay2 may receive a LMR to initiate a PC5 connection modification procedure with Relay1. The DCR or LMR received from Relay1 may include, for example, one or more of: information (e.g., User Info ID) of the source End UE (here, UE1), a delegate IP address assignment indication, information (e.g., User Info ID) of the sender U2U Relay (here, Relay1), information (e.g., User Info ID) of the target End UE (here, UE2), routing information (e.g., sequence of User Info IDs; here, [User Info ID of Relay2]), hop count from the source End UE (here, hop count =1), RSC, and others. Destination Layer-2 ID of target End UE (here, UE2) may also be included.

Relay2 may store or add a unicast route to a first source End UE (UE1) in a Unicast Routing Table 620. Relay1 may be between UE1 and Relay2. If the RSC in the received DCR matches any RSC that Relay2 supports, Relay2 may respond by establishing the security with Relay1 before adding the route entry to UE1 into its Unicast Routing Table (with matching RSC). If the RSC in the received LMR matches any RSC that Relay2 supports, Relay2 may add a route entry to UE1 into its Unicast Routing Table (with matching RSC). The route entry to UE1 in Relay2's Unicast Routing Table may include, for example, one or more of: Destination: User Info ID of UE1; number of hops to Destination: hop count in the received DCR/LMR plus 1, here 2; next hop: User Info ID of Relay1 (User Info ID of sender U2U Relay in the received DCR/LMR); Destination Layer-2 ID of Next Hop:
Source Layer-2 ID of Relay1.

Relay2 may send a DCR or LMR 630 to a target End UE (UE2). If a PC5 connection between Relay2 and UE2 does not exist, Relay2 may send a DCR to initiate a PC5 connection setup procedure with UE2. Otherwise, Relay2 may send a LMR to initiate a PC5 connection modification procedure with UE2. If a PC5 connection between Relay2 and UE1 does not exist, and if the Destination Layer-2 ID of the target End UE is provided in the received DCR/LMR, Relay2 may send a DCR via unicast to initiate the PC5 connection setup procedure with the target End UE (here, UE2). If the Destination Layer-2 ID of the target End UE is not provided in the received DCR/LMR, Relay2 may send a DCR via broadcast to initiate the PC5 connection setup procedure with UE2. The DCR or LMR sent by Relay2 may include, for example, one or more of: information (e.g., User Info ID) of the source End UE (here, UE1), a delegate IP address assignment indication, information (e.g., User Info ID) of sender U2U Relay (here, Relay2), information (e.g., User Info ID) of target End UE (here, UE2), hop count from the source End UE (hop count in the received DCR/LMR plus 1; here, hop count =2), RSC, and others.

Relay2 may receive a Direct Communication Accept (DCA) or Link Modification Accept (LMA) 640 from UE2. The received DCA/LMA may be based on the next hop information of the route entry to UE1 (source End UE) in the Unicast Routing Table (with matching RSC) on UE2. If a PC5 connection between UE2 and Relay2 does not exist, Relay2 may receive a DCA from UE2. Otherwise, Relay2 may receive a LMA from UE2. The DCA/LMA received from UE1 may include, for example, one or more of: information (e.g., User Info ID) of the source End UE (here, UE1), information (e.g., User Info ID) of the target End UE (here, UE2), hop count from the target End UE (here, hop count =0), RSC, and others.

Relay2 may store or add a route entry to UE1 into its Unicast Routing Table (with matching RSC) 650. The route entry to UE2 in Relay2's Unicast Routing Table may include, for example, one or more of: Destination: User Info ID of UE2; number of hops to Destination: hop count in the received DCA/LMA plus 1; here 1; next hop: directly connected; Destination Layer-2 ID of Next Hop: Source Layer-2 ID of UE2.

Relay2 may assign a source IP address and a target IP address and send the IP addresses to UE2 660. Relay2 may act as a DHCP server or an IPv6 Router. Relay2 may receive a request for a (target) IP address from UE2. Relay2 may send the target IP address to UE2. If a delegate IP address assignment indication is included in the DCR/LMR sent to UE2, UE2 may request (i.e. Relay2 may receive a request for) a (source) IP address for the source End UE (here, UE1). Relay2 may send the source IP address to UE2.

After Relay2 completes the IP address assignment procedure with UE2 for the source and target IP addresses, Relay2 may store an association of target User Info ID and target IP address for DNS lookup and IP traffic routing and add a route entry to UE2 into its Unicast IP Routing Table (with matching RSC) 670. This may be based on the route entry to UE2 in its Unicast Routing Table and the association between the target User Info ID and the assigned target IP address. The route entry to UE2 in Relay2's Unicast IP Routing Table may include, for example, one or more of: Destination: IP address of UE2; number of hops to Destination: 1 (directly connected); Destination Layer-2 ID of Next Hop: Source Layer-2 ID of UE2. Relay2 may store an association of source User Info ID and source IP address for DNS lookup and IP traffic routing and add a route entry 518 to UE1 into its Unicast IP Routing Table (with matching RSC), based on the route entry to UE1 in its Unicast Routing Table and the association between source User Info ID and the assigned source IP address. The route entry to UE1 in Relay2's Unicast IP Routing Table may include, for example, one or more of: Destination: IP address of UE1; number of hops to Destination: here 2; Destination Layer-2 ID of Next Hop: Source Layer-2 ID of Relay1.

Relay2 may send a DCA or LMA to Relay1 680. The DCA or LMA may be based on the next hop information to UE1 in its Unicast Routing Table (with matching RSC). If a PC5 connection between Relay2 and Relay1 does not exist, Relay2 may send a DCA to Relay1. Otherwise, Relay2 may send a LMA to Relay1. If a delegate IP address assignment indication is included in the received DCR/LMR from Relay1, Relay2 may wait for the completion of the (e.g., DHCP) IP address assignment procedure with UE2 (for both source IP address and target IP address) before sending out the DCA/LMA to Relay1. A timer may be used to limit the amount of time Relay2 waits for the completion of the (e.g., DHCP) IP address assignment procedure with UE2 to include the source and target IP addresses in the DCA/LMA sending to Relay1. The DCA/LMA sent by Relay2 may include, for example, one or more of: information (e.g., User Info ID) of the source End UE (here, UE1), source IP address (here, IP address of UE1), information (e.g., User Info ID) of the target End UE (here, UE2), target IP address (here, IP address of UE2), information (e.g., User Info ID) of the sender U2U Relay (here, Relay2), hop count from the target End UE (hop count in the received DCA/LMA plus 1; here, hop count =1), RSC, and others.

In an embodiment, a Unicast IP Routing Table may be set up with a predetermined IP address. A source End UE (UE1) may include a source IP address in DCR/LMR. Unicast Routing Tables and Unicast IP Routing Tables may be updated hop by hop to include a route entry to UE1 on each hop. UE2 may include a target IP address or IP address request indication in the DCA/LMA sending to Relay2. Relay2 may include a target IP address in the DCA/LMA sending to UE1, via Relay1. Unicast Routing Tables and Unicast IP Routing Tables may be updated hop by hop to include a route entry to UE2 on each hop.

UE1 (Source End UE) may send a DCR or LMR to Relay1, which may include routing information obtained from UE-to-UE Relay Discovery. UE1 may send a preconfigured or previously assigned source IP address (here, IP address of UE1) to Relay1 in the LMR or during security establishment with Relay1 after sending a DCR. UE1 may receive the DCA/LMA from Relay1, which may include the target IP address (here, IP address of UE2). UE1 may add a route entry to UE2 into its Unicast Routing Table. UE1 may add a route entry to UE1 into its Unicast IP Routing Table based on the route entry to UE1 in its Unicast Routing Table and an association between the target User Info ID and the received target IP address. UE1 may exchange user plane IP traffic with UE2 via the Unicast IP Routing Tables hop by hop.

Relay1 (U2U Relay UE) may receive the DCR or LMR from UE1. Relay1 may perform security establishment with UE1 if a DCR is received. Relay1 may receive the source IP address (here, IP address of UE1) in the LMR or during security establishment with UE1. Relay1 may add a route entry to UE1 into its Unicast Routing Table. Relay1 may add a route entry to UE1 into its Unicast IP Routing Table, based on the route entry to UE1 in its Unicast Routing Table and an association between the source User Info ID and the received source IP address. Relay1 may send a DCR or LMR to Relay2, which may include routing information (e.g., obtained by removing itself out of the routing information received from UE1). Relay1 may send the source IP address (here, IP address of UE1) to Relay2 in a LMR or during security establishment with Relay2 after sending a DCR. Relay1 may receive a DCA/LMA from Relay2, which may include the target IP address (here, IP address of UE2). Relay1 may add a route entry to UE2 into its Unicast Routing Table. Relay1 may add a route entry to UE2 into its Unicast IP Routing Table based on the route entry to UE1 in its Unicast Routing Table and an association between the target User Info ID and the received target IP address. Relay1 may send a DCA or LMA to UE1, which may include the target IP address (here, IP address of UE2).

Relay2 (U2U Relay UE) may receive a DCR or LMR from Relay1. Relay2 may perform security establishment with Relay1 if a DCR is received. Relay2 may receive the source IP address (here, IP address of UE1) in the LMR or during security establishment with Relay1. Relay2 may add a route entry to UE1 into its Unicast Routing Table, with Relay1 as a next hop. Relay2 may add a route entry to UE1 into its Unicast IP Routing Table, based on the route entry to UE1 in its Unicast Routing Table and an association between source User Info ID and the assigned source IP address. Relay2 may send a DCR or LMR to UE2. Relay2 may send the source IP address (here, IP address of UE1) to UE2 in the LMR or during security establishment with UE2 after sending DCR. Relay2 may receive a DCA/LMA from UE2, which may include the target IP address (here, IP address of UE2), if a preconfigured or previously assigned IP address is available on UE2. Relay2 may add a route entry to UE2 into its Unicast Routing Table. Relay2 may assign a (target) IP address (acting as a DHCP server or an IPv6 Router) for UE2, if requested. Relay2 may add a route entry to UE2 into its Unicast IP Routing Table, based on the route entry to UE1 in its Unicast Routing Table and an association between the target User Info ID and the assigned target IP address. Relay2 may send a DCA or LMA to Relay1, which may include the target IP address (here, IP address of UE2). Relay2 may wait for the completion of the (e.g., DHCP) IP address assignment with UE2 before sending out the DCA/LMA to Relay1, if an IP address request indication is included in the received DCA/LMA from UE2.

UE1 (Target End UE) may receive a DCR or LMR from Relay2. UE2 may perform security establishment with Relay2 if DCR is received. UE2 may receive the source IP address (here, IP address of UE1) in the LMR or during security establishment with Relay2. UE2 may add a route entry to UE1 into its Unicast Routing Table, with Relay2 as a next hop. UE2 may add a route entry to UE1 into its Unicast IP Routing Table, based on the route entry to UE1 in its Unicast Routing Table and an association between the source User Info ID and the received source IP address. UE2 may send a DCA or LMA to Relay2. If a preconfigured or previously assigned IP address of UE2 is available, UE2 may include the target IP address in the DCA/LMA sent to Relay2. Otherwise, UE2 may include an IP address request indication in the DCA/LMA sent to Relay2 and then initiate the IP address assignment procedure with Relay2 (acting as a DHCP server or an IPv6 Router). UE2 may request and receive the target IP address from Relay2, if a preconfigured or previously assigned IP address of UE2 is not available. UE2 may exchange user plane IP traffic with UE1 via the Unicast IP Routing Tables hop by hop.

In an embodiment, a Unicast IP Routing Table may be set up hop by hop during a link establishment procedure for user plane IP traffic routing if a source IP address has been previously determined or preconfigured. The target IP address may be previously determined or preconfigured or requested from an immediate U2U Relay of the target End UE acting as a DHCP server (or an IPv6 Router).

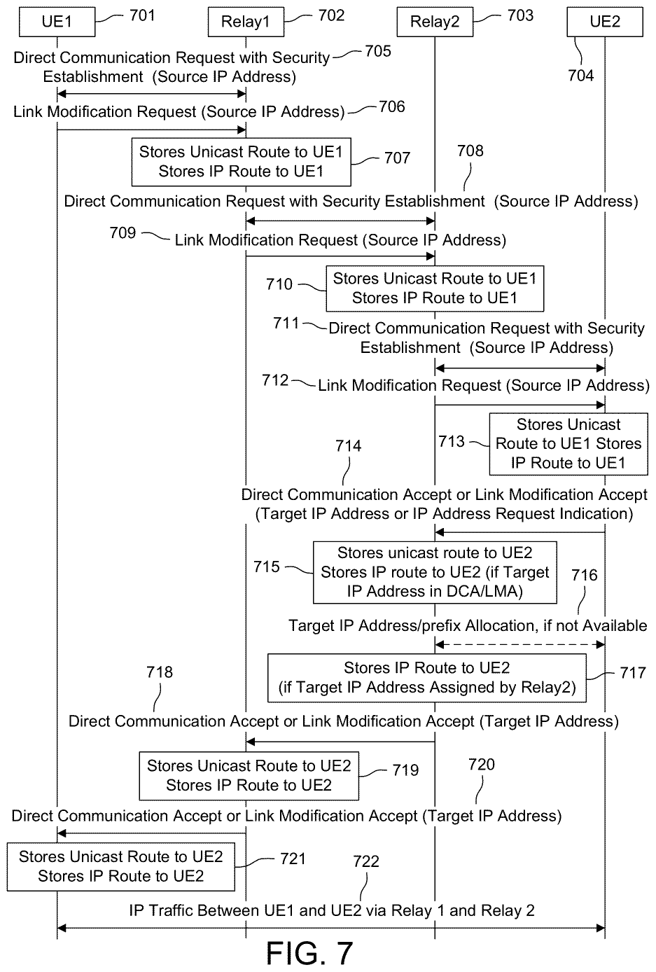

FIG. 7 shows an example procedure for Unicast IP Routing Table setup with a predetermined IP address.

Service authorization and provisioning may be performed for UE1 701 (source End UE), UE2 704 (target End UE), Relay1 702, and Relay2 703. UE1 may have discovered UE2 via UE-to-UE Relay Discovery (here, [UE1, Relay1, Relay2, UE2]). UE1 may have a preconfigured or previously assigned IP address and UE2 may have a preconfigured or previously assigned IP address.

In a UE-to-UE Relay mesh network, it is possible that UE1 has previously set up an end-to-end connection with another End UE (e.g., UE3) via another set of U2U Relays (e.g., Relay3 and Relay4), with an IP address assigned by Relay3, before the unicast link between UE1 and Relay1 is established. UE1 may reuse the IP address assigned by Relay3 to communicate with UE2 to save the IP address space.

UE1 701 (source End UE) may send a Direct Communication Request (DCR) 705 or Link Modification Request (LMR) 706 to Relay1 702 based on the routing information obtained from UE-to-UE Relay Discovery. If a PC5 connection between UE1 and Relay1 does not exist, UE1 may send a DCR to initiate a PC5 connection setup procedure with Relay1. Otherwise, UE1 may send a LMR to initiate a PC5 connection modification procedure with Relay1. The DCR or LMR sent by UE1 may include, for example, one or more of: information (e.g., User Info ID) of the source End UE (here, UE1), information (e.g., User Info ID) of the target End UE (here, UE2), routing information (e.g., sequence of User Info IDs; here, [User Info ID of Relay1, User Info ID of Relay2]), hop count from the source End UE (here, hop count =0), RSC, and others. Destination Layer-2 ID of target End UE (here, UE2) may also be included. In addition, the source End UE (here, UE1) may provide its preconfigured or previously assigned IP address in the LMR or during the security establishment procedure after sending the DCR.

Relay1 702 may receive the DCR 705 or LMR 706 from UE1 701. If the RSC in the received DCR matches any RSC that Relay1 supports, Relay1 may respond by establishing the security with UE1 before adding the route entry to UE1 into its Unicast Routing Table (with matching RSC). If the RSC in the received LMR matches any RSC that Relay1 supports, Relay1 may add a route entry 707 to UE1 into its Unicast Routing Table (with matching RSC). The route entry to UE1 in Relay1's Unicast Routing Table may include, for example, one or more of: Destination: User Info ID of UE1; number of hops to Destination: hop count in the received DCR/LMR plus 1, here 1; Next Hop: directly connected; Destination Layer-2 ID of Next Hop: Source Layer-2 ID of UE1. If the source IP address (here IP address of UE1) is received in the LMR or during the security establishment procedure after receiving DCR, Relay1 may store an association of the source User Info ID and source IP address for DNS lookup and IP traffic routing and may add a route entry 707 to UE1 into its Unicast IP Routing Table (with matching RSC), based on the route entry to UE1 in its Unicast Routing Table and an association between the source User Info ID and the received source IP address. The route entry to UE1 in Relay1's Unicast IP Routing Table may include, for example, one or more of: Destination: IP address of UE1; number of hops to Destination: 1 (directly connected); Destination Layer-2 ID of Next Hop: Source Layer-2 ID of UE1.

Relay1 702 may send a DCR 708 or LMR 709 to Relay2 703 based on the routing information received in the DCR/LMR from UE1. If a PC5 connection between Relay1 and Relay2 does not exist, Relay1 may send a DCR to initiate a PC5 connection setup procedure with Relay2. Otherwise, Relay1 may send a LMR to initiate a PC5 connection modification procedure with Relay2. The DCR or LMR sent by Relay1 may include, for example, one or more of: information (e.g., User Info ID) of the source End UE (here, UE1), information (e.g., User Info ID) of the sender U2U Relay (here, Relay1), information (e.g., User Info ID) of the target End UE (here, UE2), routing information (e.g., sequence of User Info IDs; here, [User Info ID of Relay2] obtained by removing itself out of the routing information received from UE1), hop count from the source End UE (hop count in the received DCR/LMR plus 1; here, hop count =1), RSC, and others. Destination Layer-2 ID of target End UE (here, UE2) may also be included. In addition, Relay1 may include the source IP address (here, IP address of UE1) in the LMR or during the security establishment procedure after sending a DCR.

Relay2 703 may receive the DCR 708 or LMR 709 from Relay1 702. If the RSC in the received DCR matches any RSC that Relay2 supports, Relay2 may respond by establishing the security with Relay1 before adding the route entry to UE1 into its Unicast Routing Table (with matching RSC). If the RSC in the received LMR matches any RSC that Relay2 supports, Relay2 may add a route entry to UE1 into its Unicast Routing Table (with matching RSC). The route entry to UE1 in Relay2's Unicast Routing Table may include, for example, one or more of: Destination: User Info ID of UE1; number of hops to Destination: hop count in the received DCR/LMR plus 1,here 2; Next Hop: User Info ID of Relay1 (User Info ID of the sender U2U Relay in the received DCR/LMR); Destination Layer-2 ID of Next Hop: Source Layer-2 ID of Relay1. If the source IP address (here, IP address of UE1) is received in the LMR or during the security establishment procedure after receiving DCR, Relay2 may store an association of the source User Info ID and source IP address for DNS lookup and IP traffic routing and add a route entry 710 to UE1 into its Unicast IP Routing Table (with matching RSC), based on the route entry to UE1 in its Unicast Routing Table and the association between the source User Info ID and the received source IP address. The route entry to UE1 in Relay2's Unicast IP Routing Table may include, for example, one or more of: Destination: IP address of UE1; number of hops to Destination: here 2; Destination Layer-2 ID of Next Hop: Source Layer-2 ID of Relay1.

Relay2 703 may send a DCR 711 or LMR 712 to UE2 704 (target End UE) based on the routing information received in the DCR/LMR from Relay1 (here, since User Info ID of Relay2 is the only User Info ID in the received routing information, Relay2 is directly connected to the target End UE). If a PC5 connection between Relay2 and UE2 does not exist, Relay2 may send a DCR to initiate a PC5 connection setup procedure with UE2. Otherwise, Relay2 may send a LMR to initiate a PC5 connection modification procedure with UE2. If a PC5 connection between Relay2 and UE1 does not exist, and if the Destination Layer-2 ID of the target End UE is provided in the received DCR/LMR message, Relay2 may send a DCR via unicast to initiate the PC5 connection setup procedure with the target End UE (here, UE2). If the Destination Layer-2 ID of the target End UE is not provided in the received DCR/LMR, Relay2 may send a DCR via broadcast to initiate the PC5 connection setup procedure with UE2. The DCR or LMR sent by Relay2 may include, for example, one or more of: information (e.g., User Info ID) of the source End UE (here, UE1), information (e.g., User Info ID) of the sender U2U Relay (here, Relay2), information (e.g., User Info ID) of the target End UE (here, UE2), hop count from the source End UE (hop count in the received DCR/LMR plus 1; here, hop count =2), RSC, and others. In addition, Relay2 may include the source IP address (here, IP address of UE1) in the LMR or during the security establishment procedure after sending DCR.

UE2 704 may receive the DCR 711 or LMR 712 from Relay2 703. If the RSC in the received DCR matches any RSC that UE2 supports, UE2 may respond by establishing the security with Relay2 before adding the route entry 713 to UE1 into its Unicast Routing Table. If the RSC in the received LMR matches any RSC that UE2 supports, UE2 may add a route entry 713 to UE1 into its Unicast Routing Table (with matching RSC). The route entry to UE1 in UE2's Unicast Routing Table may include, for example, one or more of: Destination: User Info ID of UE1; number of hops to Destination: hop count in the received DCR/LMR plus 1, here 3; Next Hop: User Info ID of Relay2 (User Info ID of sender U2U Relay in the received DCR/LMR); Destination Layer-2 ID of Next Hop: Source Layer-2 ID of Relay2. If the source IP address (here, IP address of UE1) is received in the LMR or during the security establishment procedure after receiving the DCR, UE2 may store an association of source User Info ID and source IP address for IP traffic routing and add a route entry 713 to UE1 into its Unicast IP Routing Table (with matching RSC), based on the route entry to UE1 in its Unicast Routing Table and the association between the source User Info ID and the received source IP address. The route entry to UE1 in UE2's Unicast IP Routing Table may include, for example, one or more of: Destination: IP address of UE1; number of hops to Destination: here, 3; Destination Layer-2 ID of Next Hop: Source Layer-2 ID of Relay2.

UE2 704 may send a Direct Communication Accept (DCA) or Link Modification Accept (LMA) 714 to Relay2 703 based on the next hop information of the route entry to UE1 (source End UE) in the Unicast Routing Table (with matching RSC). If a PC5 connection between UE2 and Relay2 does not exist, UE2 may send a DCA to Relay2. Otherwise, UE1 may send a LMA to Relay2. The DCA/LMA sent by UE1 may include, for example, one or more of: information (e.g., User Info ID) of the source End UE (here, UE1), information (e.g., User Info ID) of the target End UE (here, UE2), hop count from the target End UE (here, hop count =0), RSC, and others. If a previously determined target IP address (here, IP address of UE2) is available, UE2 may include the target IP address in the DCA/LMA sent to Relay2. Otherwise, UE2 may include an IP address request indication in the DCA/LMA sent to Relay2 and then initiate the IP address assignment procedure with Relay2 (acting as a DHCP server or an IPv6 Router).

Relay2 703 may receive the DCA or LMA 714 from UE 2 704. Relay2 may add a route entry 715 to UE 2 into its Unicast Routing Table (with matching RSC). The route entry to UE2 in Relay2's Unicast Routing Table may include, for example, one or more of: Destination: User Info ID of UE2; number of hops to Destination: hop count in the received DCA/LMA plus 1, here 1; Next Hop: directly connected; Destination Layer-2 ID of Next Hop: Source Layer-2 ID of UE2. If the target IP address (here, IP address of UE2) is included in the received DCA/LMA, or upon the completion of the IP address assignment procedure with UE2, Relay2 may store an association of the target User Info ID and target IP address for DNS lookup and IP traffic routing and add a route entry 715 to UE2 into its Unicast IP Routing Table (with matching RSC), based on the route entry to UE2 in its Unicast Routing Table and the association between the target User Info ID and target IP address. The route entry to UE2 in Relay2's Unicast IP Routing Table may include, for example, one or more of: Destination: IP address of UE2; number of hops to Destination: 1 (directly connected); Destination Layer-2 ID of Next Hop: Source Layer-2 ID of UE2.

If there is no previously determined target IP address (here, IP address of UE2) available, UE2 may request an IP address 716 from Relay2 (acting as a DHCP server or an IPv6 Router). After receiving the assigned IP address from Relay2, UE2 may store the assigned (target) IP address for Layer-3 IP communication.

If the target IP address is assigned by Relay2, Relay2 may store an association of the target User Info ID and the assigned target IP address (here, IP address of UE2) for DNS lookup and IP traffic routing and add a route entry 717 to UE2 into its Unicast IP Routing Table (with matching RSC), based on the route entry to UE2 in its Unicast Routing Table and the association between the target User Info ID and target IP address. The route entry to UE2 in Relay2's Unicast IP Routing Table may include, for example, one or more of: Destination: IP address of UE2; number of hops to Destination: 1 (directly connected); Destination Layer-2 ID of Next Hop: Source Layer-2 ID of UE2.

Relay2 703 may send a DCA or LMA 718 to Relay1 702 based on the next hop information to UE1 in its Unicast Routing Table (with matching RSC). If a PC5 connection between Relay2 and Relay1 does not exist, Relay2 may send a DCA to Relay1. Otherwise, Relay2 may send a LMA to Relay1. If an IP address request indication is included in the received DCA/LMA from UE2, then Relay2 may wait for the completion of the (e.g., DHCP) IP address assignment procedure with UE2 before sending out the DCA/LMA to Relay1. A timer may be used to limit the amount of time Relay2 waits for the completion of the (e.g., DHCP) IP address assignment procedure with UE2 to include the target IP address in the DCA/LMA sending to Relay1. The DCA/LMA sent by Relay2 may include, for example, one or more of: information (e.g., User Info ID) of the source End UE (here, UE1), information (e.g., User Info ID) of the target End UE (here, UE2), target IP address (here, IP address of UE2), information (e.g., User Info ID) of the sender U2U Relay (here, Relay2), hop count from the target End UE (hop count in the received DCA/LMA plus 1; here, hop count =1), RSC, and others.

Relay1 702 may receive the DCA or LMA 718 from Relay2 703. Relay1 may add a route entry 719 to UE1 into its Unicast Routing Table (with matching RSC). The route entry to UE2 in Relay1's Unicast Routing Table may include, for example, one or more of: Destination: User Info ID of UE2; number of hops to Destination: hop count in the received DCA/LMA plus 1, here 2; Next Hop: User Info ID of Relay2 (User Info ID of sender U2U Relay in the received DCA/LMA); Destination Layer-2 ID of Next Hop: Source Layer-2 ID of Relay2. If the target IP address (here, IP address of UE2) is included in the received DCA/LMA, Relay1 may store an association of the target User Info ID and target IP address for DNS lookup and IP traffic routing and add a route entry 719 to UE1 into its Unicast IP Routing Table (with matching RSC) based on the route entry to UE2 in its Unicast Routing Table and the association between the target User Info ID and the received target IP address. The route entry to UE2 in Relay1's Unicast IP Routing Table may include, for example, one or more of: Destination: IP address of UE2; number of hops to Destination: here 2; Destination Layer-2 ID of Next Hop: Source Layer-2 ID of Relay2.

Relay1 702 may send a DCA or LMA 720 to UE1 701 based on the next hop (Destination Layer-2 ID) information in the Unicast Routing Table (with matching RSC). If a PC5 connection between Relay1 and UE1 does not exist, Relay1 may send a DCA to UE1. Otherwise, Relay1 may send a LMA to UE1. The DCA/LMA sent by Relay1 may include, for example, one or more of: information (e.g., User Info ID) of the source End UE (here, UE1), information (e.g., User Info ID) of the target End UE (here, UE2), target IP address (here, IP address of UE2), information (e.g., User Info ID) of the sender U2U Relay (here, Relay1), hop count from the target End UE (hop count in the received DCA/LMA plus 1; here, hop count =2), RSC, and others.

UE 1 701 may receive the DCA or LMA 720 from Relay1 702. UE1 may add a route entry 721 to UE 2 into its Unicast Routing Table (with matching RSC). The route entry to UE2 in UE1's Unicast Routing Table may include, for example, one or more of: Destination: User Info ID of UE2; number of hops to Destination: hop count in the received DCA/LMA plus 1, here 3; Next Hop: User Info ID of Relay1 (User Info ID of sender U2U Relay in the received DCA/LMA); Destination Layer-2 ID of Next Hop: Source Layer-2 ID of Relay1. If the target IP address (here, IP address of UE2) is included in the received DCA/LMA, UE1 may store an association of the target User Info ID and target IP address for IP traffic routing and add a route entry 721 to UE1 into its Unicast IP Routing Table (with matching RSC) based on the route entry to UE2 in its Unicast Routing Table and the association between the target User Info ID and the received target IP address. The route entry to UE2 in UE1's Unicast IP Routing Table may include, for example, one or more of: Destination: IP address of UE2; number of hops to Destination: here 3; Destination Layer-2 ID of Next Hop: Source Layer-2 ID of Relay1.

UE1 701 (source End UE) may communicate 722 (e.g. IP traffic) with UE 2 704 (target End UE) in the user plane via the Unicast IP Routing Tables hop by hop and vice versa.

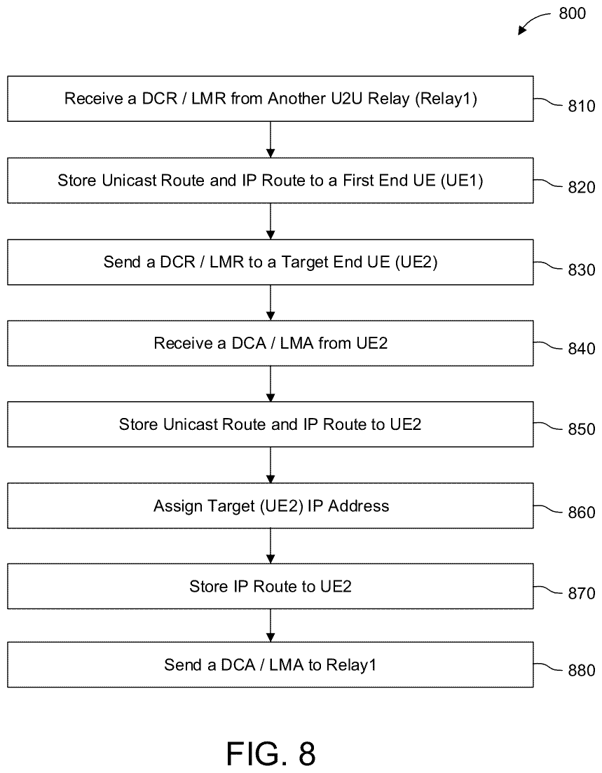

FIG. 8 shows an example procedure 800 for a U2U relay UE (Relay2) for Unicast IP Routing Table setup with a predetermined IP address. A first End UE (UE1) may have a preconfigured or previously assigned IP address. A second End UE (UE2) may have a preconfigured or previously assigned IP address.

Relay2 may receive a DCR or LMR 810 from Relay1. If a PC5 connection between Relay1 and Relay2 does not exist, Relay2 may receive a DCR to initiate a PC5 connection setup procedure with Relay1. Otherwise, Relay2 may receive a LMR to initiate a PC5 connection modification procedure with Relay1. The DCR or LMR received from Relay1 may include, for example, one or more of: information (e.g., User Info ID) of the source End UE (here, UE1), information (e.g., User Info ID) of the sender U2U Relay (here, Relay1), information (e.g., User Info ID) of the target End UE (here, UE2), routing information (e.g., sequence of User Info IDs, obtained by removing itself out of the routing information received from UE1), hop count from the source End UE (here, hop count =1), RSC, and others. Destination Layer-2 ID of target End UE (here, UE2) may also be included. In addition, Relay1 may include the source IP address (here, IP address of UE1) in the LMR or during the security establishment procedure after sending a DCR.

Relay2 may store or add a unicast route 820 to UE1. Relay2 may store or add unicast IP route 820 to UE1. Relay2 may store or add the unicast route to UE1 in a Unicast Routing Table. Relay2 may store or add the IP route to UE1 in an IP Unicast Routing Table.

If the RSC in the received DCR matches any RSC that Relay2 supports, Relay2 may respond by establishing the security with Relay1 before adding the route entry to UE1 into its Unicast Routing Table (with matching RSC). If the RSC in the received LMR matches any RSC that Relay2 supports, Relay2 adds a route entry to UE1 into its Unicast Routing Table (with matching RSC). The route entry to UE1 in Relay2's Unicast Routing Table may include, for example, one or more of: Destination: User Info ID of UE1; number of hops to Destination: hop count in the received DCR/LMR plus 1, here 2; Next Hop: User Info ID of Relay1 (User Info ID of the sender U2U Relay in the received DCR/LMR); Destination Layer-2 ID of Next Hop: Source Layer-2 ID of Relay1. If the source IP address (here, IP address of UE1) is received in the LMR or during the security establishment procedure after receiving DCR, Relay2 may store an association of the source User Info ID and source IP address for DNS lookup and IP traffic routing and add a route entry to UE1 into its Unicast IP Routing Table (with matching RSC), based on the route entry to UE1 in its Unicast Routing Table and the association between the source User Info ID and the received source IP address. The route entry to UE1 in Relay2's Unicast IP Routing Table may include, for example, one or more of: Destination: IP address of UE1; number of hops to Destination: here 2; Destination Layer-2 ID of Next Hop: Source Layer-2 ID of Relay1.

Relay2 may send a DCR or LMR 830 to a target End UE (UE2). If a PC5 connection between Relay2 and UE2 does not exist, Relay2 may send a DCR to initiate a PC5 connection setup procedure with UE2. Otherwise, Relay2 may send a LMR to initiate a PC5 connection modification procedure with UE2. If a PC5 connection between Relay2 and UE1 does not exist, and if the Destination Layer-2 ID of the target End UE is provided in the received DCR/LMR message, Relay2 may send a DCR via unicast to initiate the PC5 connection setup procedure with the target End UE (here, UE2). If the Destination Layer-2 ID of the target End UE is not provided in the received DCR/LMR, Relay2 may send a DCR via broadcast to initiate the PC5 connection setup procedure with UE2. The DCR or LMR sent by Relay2 may include, for example, one or more of: information (e.g., User Info ID) of the source End UE (here, UE1), information (e.g., User Info ID) of the sender U2U Relay (here, Relay2), information (e.g., User Info ID) of the target End UE (here, UE2), hop count from the source End UE (hop count in the received DCR/LMR plus 1; here, hop count =2), RSC, and others. In addition, Relay2 may include the source IP address (here, IP address of UE1) in the LMR or during the security establishment procedure after sending DCR.

Relay2 may receive a Direct Communication Accept (DCA) or Link Modification Accept (LMA) 840 from UE2. The DCA/LMA may be based on the next hop information of the route entry to UE1 (source End UE) in the Unicast Routing Table (with matching RSC) on UE2. If a PC5 connection between UE2 and Relay2 does not exist, Relay2 may receive a DCA from UE2. Otherwise, Relay2 may receive a LMA from UE2. The DCA/LMA received from UE1 may include, for example, one or more of: information (e.g., User Info ID) of the source End UE (here, UE1), information (e.g., User Info ID) of the target End UE (here, UE2), hop count from the target End UE (here, hop count =0), RSC, and others. If a previously determined target IP address (here, IP address of UE2) is available, UE2 may include the target IP address in the DCA/LMA sent to Relay2. Otherwise, UE2 may include an IP address request indication in the DCA/LMA sent to Relay2 and then initiate the IP address assignment procedure with Relay2 (acting as a DHCP server or an IPv6 Router).

Relay2 may store or add a route entry to UE1 into its Unicast Routing Table (with matching RSC) 850. The route entry to UE2 in Relay2's Unicast Routing Table may include, for example, one or more of: Destination: User Info ID of UE2; number of hops to Destination: hop count in the received DCA/LMA plus 1, here 1; Next Hop: directly connected; Destination Layer-2 ID of Next Hop: Source Layer-2 ID of UE2. If the target IP address (here, IP address of UE2) is included in the received DCA/LMA, Relay2 may store an association of the target User Info ID and target IP address for DNS lookup and IP traffic routing and store or add a route entry to UE1 into its Unicast IP Routing Table (with matching RSC) 850, based on the route entry to UE2 in its Unicast Routing Table and the association between the target User Info ID and target IP address. The route entry to UE2 in Relay2's Unicast IP Routing Table may include, for example, one or more of: Destination: IP address of UE2; number of hops to Destination: 1 (directly connected); Destination Layer-2 ID of Next Hop: Source Layer-2 ID of UE2.

Relay2 may assign and send an IP address to UE2 860, if an IP address of UE2 is not received in the DCA/LMA 840. If there is no previously determined target IP address (here, IP address of UE2) available in the received DCA/LMA, Relay2 may receive a request for an IP address from UE2. Relay2 may act as a DHCP server or an IPv6 Router. Relay2 may assign and send an IP address to UE2 in response to the request. After receiving the assigned IP address from Relay2, UE2 may store the assigned (target) IP address for Layer-3 IP communication.

Relay2 may store or add an IP route 870 to UE1. Relay2 may store an association of the target User Info ID and the assigned target IP address (here, IP address of UE2) for DNS lookup and IP traffic routing and add a route entry to UE2 into its Unicast IP Routing Table (with matching RSC), based on the route entry to UE2 in its Unicast Routing Table and the association between the target User Info ID and target IP address. The route entry to UE2 in Relay2's Unicast IP Routing Table may include, for example, one or more of: Destination: IP address of UE2; number of hops to Destination: 1 (directly connected); Destination Layer-2 ID of Next Hop: Source Layer-2 ID of UE2.

Relay2 may send a DCA or LMA 880 to Relay1. Relay2 may send the DCA/LMA based on the next hop information to UE1 in its Unicast Routing Table (with matching RSC). If a PC5 connection between Relay2 and Relay1 does not exist, Relay2 may send a DCA to Relay1. Otherwise, Relay2 may send a LMA to Relay1. If an IP address request indication is included in the received DCA/LMA from UE2, then Relay2 may wait for the completion of the (e.g., DHCP) IP address assignment procedure with UE2 before sending out the DCA/LMA to Relay1. A timer may be used to limit the amount of time Relay2 waits for the completion of the (e.g., DHCP) IP address assignment procedure with UE2 to include the target IP address in the DCA/LMA sending to Relay1. The DCA/LMA sent by Relay2 may include, for example, one or more of: information (e.g., User Info ID) of the source End UE (here, UE1), information (e.g., User Info ID) of the target End UE (here, UE2), target IP address (here, IP address of UE2), information (e.g., User Info ID) of the sender U2U Relay (here, Relay2), hop count from the target End UE (hop count in the received DCA/LMA plus 1; here, hop count =1), RSC, and others.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU)-to-WTRU relay (Relay1), the method
comprising:
receiving a first message from a source WTRU (WRTU1), wherein the first message comprises a proactive domain name server (DNS) query for a target WTRU (WTRU2) Internet Protocol (IP) address;
storing a route entry to WRTU1 in a unicast routing table;
sending a second message to a second WTRU-to-WTRU relay (Relay2), wherein the second message comprises a proactive DNS query for an IP address of WTRU2;
receiving a third message from Relay2, wherein the third message comprises a proactive DNS query for an IP address of WTRU1 and comprise an IP address of WTRU2;
storing a route entry to WTRU2 in the unicast routing table;
storing an association of a user information identification (ID) of WTRU2 and the IP address of WTRU2;
storing an IP route entry to WTRU2 in a unicast IP routing table, based on the route entry to WTRU2 in the unicast routing table and the association between the user information ID of WTRU2 and the IP address of WTRU2;
sending a fourth message to WTRU1, wherein the fourth message comprises the IP address of WTRU2;
allocating and sending an IP address to WTRU1;
storing an association of a user information ID of WTRU1 and the IP address of WTRU1;
storing an IP route entry to WTRU1 in the unicast IP routing table, based on the route entry to WTRU1 in the unicast routing table and the association between the user information ID of WTRU1 and the IP address of WTRU1; and
sending a fifth message to WTRU2 via Relay2, wherein the fifth message is a DNS response message, and comprises an IP address of WTRU1.

2. The method of claim 1, wherein the first message is a direct communication request (DCR) or a link modification request (LMR) and wherein the first message further comprises one or more of: a user information identification (ID) of WTRU1; a user information ID of WTRU2; routing information based on a WTRU-to-WTRU relay discovery; an indication of a hop count from WTRU1; a relay service code (RSC); and a Layer-2 ID of WTRU2.

3. The method of claim 1, wherein the route entry to the source WTRU in the unicast routing table comprises one or more of: a user information identification (ID) of WRTU1; an indication of a number of hops to WTRU1; a next hop information (directly connected); and Layer-2 ID of WTRU1.

4. The method of claim 1, wherein the second message is a direct communication request (DCR) or a link modification request (LMR) and wherein the second message further comprises one or more of: a user information identification (ID) of WTRU1; a user information ID of Relay1; a user information ID of WTRU2; routing information; an indication of a hop count from WTRU1; a relay service code (RSC); and a Layer-2 ID of WTRU2.

5. The method of claim 1, wherein the third message is a direct communication accept (DCA) or a link modification accept (LMA) and wherein the third message further comprises one or more of: a user information identification (ID) of WTRU1; a user information ID of WTRU2; a user information ID of Relay2; an indication of a hop count from WTRU2; and a relay service code (RSC).

6. The method of claim 1, wherein the route entry to WTRU2 in the unicast routing table comprises one or more of: a user information identification (ID) of WTRU2; an indication of a number of hops to WTRU2; a user information ID of Relay2; and a Layer-2 ID of Relay2.

7. The method of claim 1, wherein the route entry to WTRU2 in the unicast IP routing table comprises one or more of: the IP address of WTRU2; an indication of a number of hops to WTRU2; and a Layer-2 ID of Relay2.

8. The method of claim 1, wherein the fourth message is a direct communication accept (DCA) or a link modification accept (LMA), and wherein the fourth message further comprises one or more of: a user information ID of WTRU1, a user information ID of WTRU2, a user information ID of Relay1, an indication of a hop count from WTRU2, and a relay service code (RSC).

9. The method of claim 1, wherein the IP route entry to WTRU1 in the unicast IP routing table comprises one or more of: the: IP address of WTRU1; an indication of a number of hops to WTRU1; and a Layer-2 ID of WTRU1.

10. The method of claim 1, wherein the fifth message is sent based on the proactive DNS query for a source IP address being included in the received third message from Relay2.

11. A wireless transmit/receive unit (WTRU)-to-WTRU relay (Relay1) comprising:
a receiver;
a processor; and
a transmitter, wherein:
the receiver is configured to receive a first message from a source WTRU (WRTU1), wherein the first message comprises a proactive domain name server (DNS) query for a target WTRU (WTRU2) Internet Protocol (IP) address;
the processor is configured to store route entry to WTRU1 in a unicast routing table;
the transmitter is configured to send a second message to a second WTRU-to-WTRU relay (Relay2), wherein the second message comprises a proactive DNS query for an IP address of WTRU2;
the receiver is further configured to receive a third message from Relay2, wherein the third message comprises a proactive DNS query for an IP address of WTRU1 and comprise an IP address of WTRU2;
the processor is further configured to store a route entry to WTRU2 in the unicast routing table;
the processor is further configured to store an association of a user information identification (ID) of WTRU2 and the IP address of WTRU2;
the processor is further configured to store an IP route entry to WTRU2 in a unicast IP routing table, based on the route entry to WTRU2 in the unicast routing table and the association between the user information ID of WTRU2 and the IP address of WTRU2;
the transmitter is further configured to send a fourth message to WTRU1, wherein the fourth message comprises the IP address of WTRU2;
the processor and the transmitter are further configured to allocate and send an IP address to WTRU1;
the processor is further configured to store an association of a user information ID of WTRU1 and the IP address of WTRU1;
the processor is further configured to store an IP route entry to WTRU1 in the unicast IP routing table, based on the route entry to WTRU1 in the unicast routing table and the association between the user information ID of WTRU1 and the IP address of WTRU1; and
the transmitter is further configured to send a fifth message to WTRU2 via Relay2, wherein the fifth message is a DNS response message, and comprises an IP address of WTRU1.

12. The WTRU-to-WTRU relay of claim 11, wherein the first message is a direct communication request (DCR) or a link modification request (LMR) and wherein the first message further comprises one or more of: a user information identification (ID) of WTRU1; a user information ID of WTRU2; routing information based on a WTRU-to-WTRU relay discovery; an indication of a hop count from WTRU1; a relay service code (RSC); and a Layer-2 ID of WTRU2.

13. The WTRU-to-WTRU relay of claim 11, wherein the route entry to the source WTRU in the unicast routing table comprises one or more of: a user information identification (ID) of WRTU1; an indication of a number of hops to WTRU1; a next hop information (directly connected); and Layer-2 ID of WTRU1.

14. The WTRU-to-WTRU relay of claim 11, wherein the second message is a direct communication request (DCR) or a link modification request (LMR) and wherein the second message further comprises one or more of: a user information identification (ID) of WTRU1; a user information ID of Relay1; a user information ID of WTRU2; routing information; an indication of a hop count from WTRU1; a relay service code (RSC); and a Layer-2 ID of WTRU2.

15. The WTRU-to-WTRU relay of claim 11, wherein the third message is a direct communication accept (DCA) or a link modification accept (LMA) and wherein the third message further comprises one or more of: a user information identification (ID) of WTRU1; a user information ID of WTRU2; a user information ID of Relay2; an indication of a hop count from WTRU2; and a relay service code (RSC).

16. The WTRU-to-WTRU relay of claim 11, wherein the route entry to WTRU2 in the unicast routing table comprises one or more of: a user information identification (ID) of WTRU2; an indication of a number of hops to WTRU2; a user information ID of Relay2; and a Layer-2 ID of Relay2.

17. The WTRU-to-WTRU relay of claim 11, wherein the route entry to WTRU2 in the unicast IP routing table comprises one or more of: the IP address of WTRU2; an indication of a number of hops to WTRU2; and a Layer-2 ID of Relay2.

18. The WTRU-to-WTRU relay of claim 11, wherein the fourth message is a direct communication accept (DCA) or a link modification accept (LMA), and wherein the fourth message further comprises one or more of: a user information ID of WTRU1, a user information ID of WTRU2, a user information ID of Relay1, an indication of a hop count from WTRU2, and a relay service code (RSC).

19. The WTRU-to-WTRU relay of claim 11, wherein the IP route entry to WTRU1 in the unicast IP routing table comprises one or more of: the: IP address of WTRU1; an indication of a number of hops to WTRU1; and a Layer-2 ID of WTRU1.

20. The WTRU-to-WTRU relay of claim 11, wherein the fifth message is sent based on the proactive DNS query for a source IP address being included in the received third message from Relay2.
